(19) United States
(12) Patent Application Publication
(10) Pub. No.: US 2017/0213389 A1
(43) Pub. Date: Jul. 27, 2017

(54) MOBILE TERMINAL AND OPERATING METHOD THEREOF

(71) Applicant: LG ELECTRONICS INC., Seoul (KR)

(72) Inventors: Miran HAN, Seoul (KR); Seunghyun YANG, Seoul (KR); Kyungin OH, Seoul (KR); Jongyoon AHN, Seoul (KR); Shinjun PARK, Seoul (KR)

(21) Appl. No.: 15/186,615

(22) Filed: Jun. 20, 2016

(30) Foreign Application Priority Data
Jan. 22, 2016 (KR) 10-2016-0008078

(51) Int. Cl. G06T 19/00; H04N 5/445

(52) U.S. Cl. CPC G06T 19/006; H04N 5/44591

(57) ABSTRACT

A mobile terminal includes a display unit that is configured to display a 360-degree image. The mobile terminal further includes a sensing unit that is configured to detect an input signal. The mobile terminal further includes a control unit. The control unit is configured to control the display unit. The control unit is further configured to control the sensing unit. The control unit is further configured to display, on the display unit, a first image at a first viewing angle in response to the sensing unit detecting a first input signal for displaying the 360-degree image at the first viewing angle. The control unit is further configured to display, on the display unit, a second image at a second viewing angle in response to the sensing unit detecting a second input signal for displaying the 360-degree image at the second viewing angle that is different than the first viewing angle.

### CROSS-REFERENCE TO RELATED APPLICATIONS

The present application claims priority under 35 U.S.C. 119 and 35 U.S.C. 365 to Korean Patent Application No. 10-2016-0008078 (filed on Jan. 22, 2016), which is hereby incorporated by reference in its entirety.

### FIELD

The present disclosure relates to a mobile terminal.

### BACKGROUND

Depending on whether terminals are movable, the terminals are divided into mobile/portable terminals and stationary terminals. Again, the mobile terminals may be divided into handheld terminals and vehicle mounted terminals depending on whether users can carry the mobile terminals personally.

Functions of the mobile terminals become diversified. For example, the functions include data and voice communication, image capturing and video recording through a camera, voice recording, music file playback through a speaker system, and an image or video output to a display unit. Some terminals may have an additional electronic game play function or a multimedia player function. Especially, recent mobile terminals may receive multicast signals for providing visual contents such as broadcasts and video or television programs.

As functions of a terminal are diversified, such a terminal may be implemented in a form of a multimedia player with multi-functions, for example, image or video capturing, playback of music or video files, game plays, and broadcast reception.

Mobile terminals may play 360-degree images. The 360-degree image means a Virtual Reality (VR) video having the angle view of 360 degrees. Unlike an existing image that shows only a view point selected by a photographer, the 360-degree image may reproduce an image in a direction or at a point, selected by a user. In some implementations, since the 360-degree image has the angle view of 360 degrees, it shows all directions to a user while rotating 360 degrees. A user may select and view a desired direction or point by using a keyboard or a mouse during the reproduction of a 360-degree image.

### SUMMARY

According to an innovative aspect of the subject matter described in this application, a mobile terminal includes a display unit that is configured to display a 360-degree image; a sensing unit that is configured to detect an input signal; and a control unit that is configured to control the display unit; control the sensing unit; display, on the display unit, a first image at a first viewing angle in response to the sensing unit detecting a first input signal for displaying the 360-degree image at the first viewing angle; and display, on the display unit, a second image at a second viewing angle in response to the sensing unit detecting a second input signal for displaying the 360-degree image at the second viewing angle that is different than the first viewing angle, where the second image includes a picture-in-picture (PIP) screen that displays predetermined content.

The mobile terminal may include one or more of the following optional features. The predetermined content includes at least one of an advertisement or a payment window. The control unit is configured to display the second image and the PIP screen by fixing the 360-degree image at the second viewing angle based on the 360-degree image being displayed for a predetermined amount of time. The control unit is configured to increase a size of the PIP screen based on the sensor unit detecting a third input signal for changing the viewing angle of the 360-degree image to the second viewing angle and based on the viewing angle of the 360-degree image approaching the second viewing angle. The control unit is configured to cover a specific object in the second image with the PIP screen. The control unit is configured to overlap and display the PIP screen on the specific object based on the specific object being moved.

The predetermined content includes a plurality of display areas for displaying the 360-degree image at different viewing angles. The control unit is configured to display a second PIP screen for displaying a display area of the plurality of display areas at a position based on the display area being moved outside of the PIP screen that includes the plurality of display areas and being moved to the position on the second image. The control unit is configured to decrease a size of the PIP screen based on the display area being moved. The control unit is configured to display, on the display unit a progress bar that represents a display time of the 360-degree image on the display unit; and display, on the display unit, the 360-degree image at a viewing angle of a display area of the plurality of display areas based on the display area being moved outside of the PIP screen that includes the plurality of display areas and being positioned at one point on the progress bar and then the progress bar approaching the one point.

The control unit is configured to display, on the display unit, a second PIP screen that connects two display areas of the plurality of display areas based on the two display areas being sequentially moved out of the PIP screen that includes the plurality of display areas and on to the second image. The control unit is configured to display, on the display unit, the second PIP screen for connecting and displaying an unselected display area and the two display areas to connect viewing angles to each other based on the viewing angles of the two display areas being spaced from each other. The control unit is configured to display, on the display unit, a second PIP screen for displaying each of two display areas of the plurality of display areas at different positions based on the two display areas being moved out of the PIP screen that includes the plurality of display areas and onto the second image at the different positions. The control unit is configured to change at least one of a number or sizes of the plurality of display areas based on the sensor unit detecting an input signal for changing a size of the predetermined content.

According to another innovative aspect of the subject matter describe in this application, a method of operating a mobile terminal includes the actions of detecting a first input signal for displaying a 360-degree image at a first viewing angle; in response to the first input signal, displaying a first image at the first viewing angle; detecting a second input signal for displaying the 360-degree image at a second viewing angle that is different from the first viewing angle; and in response to the second input signal, displaying a second image at the second viewing angle, where the second image includes a picture-in-picture (PIP) screen that displays predetermined content.

The method may include one or more of the following optional features. The predetermined content includes at least one of an advertisement or a payment window. The actions further include based on the 360-degree image being displayed for a predetermined time, displaying the second image and the PIP screen by fixing the 360-degree image at the second viewing angle. The actions further include covering a specific object in the second image by overlapping the PIP screen onto the specific object. The predetermined content includes a plurality of display areas for displaying the 360-degree image at different viewing angles. The actions further include displaying a second PIP screen for displaying a display area of the plurality of display areas at a position based on the display area being moved out of the PIP screen to the position on the second image.

### BRIEF DESCRIPTION OF THE DRAWINGS

FIG. 1 is a block diagram of an example mobile terminal.

FIG. 2 is a conceptual diagram of an example transformable mobile terminal.

FIG. 3 is a perspective view of an example watch type mobile terminal.

FIG. 4 is a perspective view of an example glass type mobile terminal.

FIGS. 5-7 are views of example mobile terminals that provide notifications on 360-degree images.

FIG. 8 is a view of an example glass-type mobile terminal that provides notification on a 360-degree image.

FIGS. 9A to 9C, 10, and 11 are views of example mobile terminals that display 360-degree images in search results.

FIGS. 12A to 12D and 13 are views of mobile terminals that provide charged images depending on a viewing angle.

FIG. 14 is a view of an example mobile terminal that recommends the replay of a 360-degree image depending on a set profile.

FIGS. 15A and 15B are views of an example mobile terminal that sets a profile for recommending the replay of a 360-degree image.

FIG. 16 is a view of an example mobile terminal that displays a screen when playing a 360-degree image.

FIGS. 17A to 23 are views of example mobile terminals that display multi views for a 360-degree image.

FIGS. 24 to 27 are views illustrating example mobile terminals that display advertisements on a 360-degree image.

FIG. 28 is a flowchart of an example operating process of an example mobile terminal.

### DETAILED DESCRIPTION

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

The terms of a singular form may include plural forms unless they have a clearly different meaning in the context.

In some implementations, in this specification, the meaning of “include,” “comprise,” “including,” or “comprising,” specifies a property, a region, a fixed number, a step, a process, an element and/or a component but does not exclude other properties, regions, fixed numbers, steps, processes, elements and/or components.

Mobile terminals described in this specification may include mobile phones, smartphones, laptop computers, terminals for digital broadcast, personal digital assistants (PDAs), portable multimedia players (PMPs), navigation systems, slate PCs, tablet PCs, ultrabooks, and wearable devices (for example, smart watches, smart glasses, and head mounted displays (HMDs)).

However, it is apparent to those skilled in the art that some implementations disclosed in this specification are applicable to stationary terminals such as digital TVs, desktop computers, and digital signage, except for the case applicable to only mobile terminals.

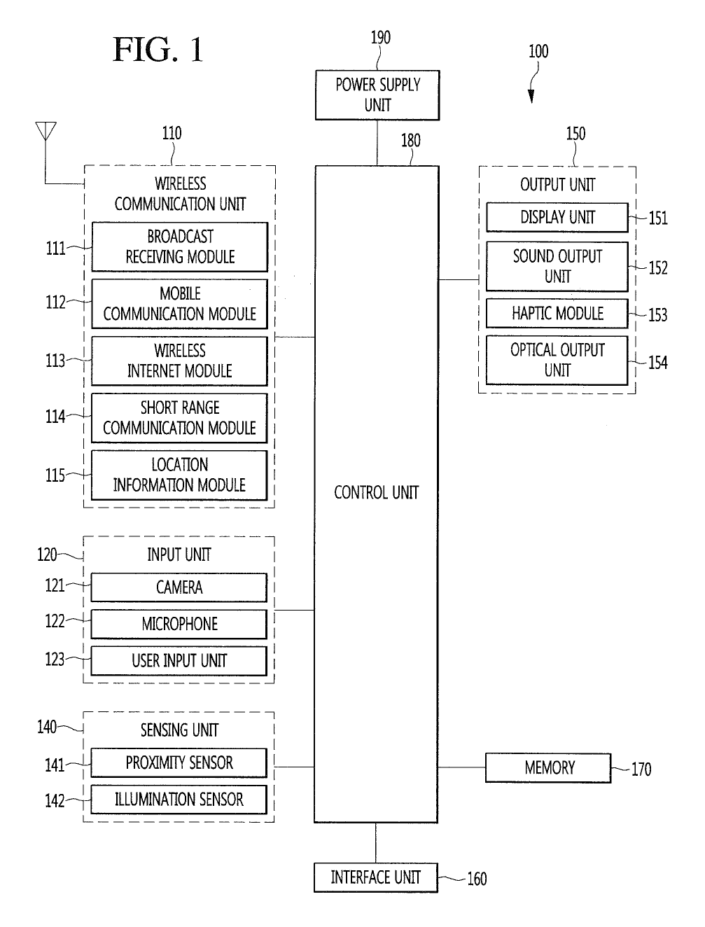

FIG. 1 is illustrates an example mobile terminal.

The mobile terminal 100 may include a wireless communication unit 110, an input unit 120, a sensing unit 140, an output unit 150, an interface unit 160, a memory 170, a control unit 180, and a power supply unit 190. In implementing a mobile terminal, components shown in FIG. 1 are not necessary, so that a mobile terminal described in this specification may include components less or more than the components listed above.

In more detail, the wireless communication unit 110 in the components may include at least one module allowing wireless communication between the mobile terminal 100 and a wireless communication system, between the mobile terminal 100 and another mobile terminal 100, or between the mobile terminal 100 and an external server. In some implementations, the wireless communication unit 110 may include at least one module connecting the mobile terminal 100 to at least one network.

The wireless communication unit 110 may include at least one of a broadcast receiving module 111, a mobile communication module 112, a wireless internet module 113, a short-range communication module 114, and a location information module 115.

The input unit 120 may include a camera 121 or an image input unit for image signal input, a microphone 122 or an audio input unit for receiving audio signal input, and a user input unit 123 (for example, a touch key and a mechanical key)) for receiving information from a user. Voice data or image data collected by the input unit 120 are analyzed and processed as a user's control command.

The sensing unit 140 may include at least one sensor for sensing at least one of information in a mobile terminal, environmental information around a mobile terminal, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (for example, the camera 121), a microphone (for example, the microphone 122), a battery gauge, an environmental sensor (for example, a barometer, a hygrometer, a thermometer, a radiation sensor, a thermal sensor, and a gas sensor), and a chemical sensor (for example, an electronic noise, a healthcare sensor, and a biometric sensor). In some implementations, a mobile terminal disclosed in this specification may combines information sensed by at least two or more sensors among such sensors and may then utilize it.

The output unit 150 is used to generate a visual, auditory, or haptic output and may include at least one of a display unit 151, a sound output unit 152, a haptic module 153, and an optical output unit 154. The display unit 151 may be formed with a mutual layer structure with a touch sensor or formed integrally, so that a touch screen may be implemented. Such a touch screen may serve as the user input unit 123 providing an input interface between the mobile terminal 100 and a user and an output interface between the mobile terminal 100 and a user at the same time.

The interface unit 160 may serve as a path to various kinds of external devices connected to the mobile terminal 100. The interface unit 160 may include at least one of a wired/wireless headset port, an external charger port, a wired/wireless data port, a memory card port, a port connecting a device equipped with an identification module, an audio Input/Output (I/O) port, a video I/O port, and an earphone port. In correspondence to that an external device is connected to the interface unit 160, the mobile terminal 100 may perform an appropriate control relating to the connected external device.

In some implementations, the memory 170 may store data supporting various functions of the mobile terminal 100. The memory 170 may store a plurality of application programs (for example, application programs or applications) running on the mobile terminal 100 and also data and commands for operations of the mobile terminal 100. At least part of such an application program may be downloaded from an external server through a wireless communication. In some implementations, at least part of such an application program may be included in the mobile terminal 100 from the time of shipment in order to perform a basic function (for example, an incoming call, a transmission function, and a message reception) of the mobile terminal 100. In some implementations, an application program may be stored in the memory 170 and installed on the mobile terminal 100, so that it may run to perform an operation (or a function) of the mobile terminal 100 by the control unit 180.

The control unit 180 may control overall operations of the mobile terminal 100 generally besides an operation relating to the application program. The control unit 180 may provide appropriate information or functions to a user or process them by processing signals, data, and information inputted/outputted through the above components or executing application programs stored in the memory 170.

In some implementations, in order to execute an application program stored in the memory 170, the control unit 180 may control at least part of the components shown in FIG. 1. In some implementations, in order to execute the application program, the control unit 180 may combine at least two of the components in the mobile terminal 100 and may then operate it.

The power supply unit 190 may receive external power or internal power under a control of the control unit 180 and may then supply power to each component in the mobile terminal 100. The power supply unit 190 includes a battery and the battery may be a built-in battery or a replaceable battery.

At least part of the each component may operate cooperatively in order to implement operations, controls, or control methods of a mobile terminal 100 according to various implementations described below. In some implementations, the operations, controls, or control methods of a mobile terminal 100 may be implemented on the mobile terminal 100 by executing at least one application program stored in the memory 170.

Hereinafter, the above-listed components are described in more detail with reference to FIG. 1.

First, in describing the wireless communication unit 110, the broadcast receiving module 111 of the wireless communication unit 110 may receive a broadcast signal and/or broadcast related information from an external broadcast management server through a broadcast channel. The broadcast channel may include a satellite channel and a terrestrial channel. At least two broadcast receiving modules for simultaneous broadcast reception for at least two broadcast channels or broadcast channel switching may be provided to the mobile terminal 100.

The broadcast management server may refer to a server for generating and transmitting broadcast signals and/or broadcast related information or a server for receiving pre-generated broadcast signals and/or broadcast related information and transmitting them to a terminal. The broadcast signals may include TV broadcast signals, radio broadcast signals, and data broadcast signals and also may include broadcast signals in a combination format thereof.

The broadcast signal may be encoded according to at least one of technical standards (or broadcast methods, for example, ISO, IEC, DVB, and ATSC) for transmitting/receiving digital broadcast signals and the broadcast reception module 111 may receive the digital broadcast signals by using a method appropriate to the technical specifications set by the technical standards.

The broadcast related information may refer to information relating to broadcast channels, broadcast programs, or broadcast service providers. The broadcast related information may be provided through a mobile communication network. In such a case, the broadcast related information may be received by the mobile communication module 112.

The broadcast related information may exist in various formats such as Electronic Program Guide (EPG) of Digital Multimedia Broadcasting (DMB) or Electronic Service Guide (ESG) of Digital Video Broadcast-Handheld (DVB-H). Broadcast signals and/or broadcast related information received through the broadcast reception module 111 may be stored in the memory 170.

The mobile communication module 112 may transmit/receive a wireless signal to/from at least one of a base station, an external terminal, and a server on a mobile communication network established according to the technical standards or communication methods for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A)).

The wireless signal may include various types of data according to a voice call signal, a video call signal, or text/multimedia message transmission/reception.

The wireless internet module 113 refers to a module for wireless internet access and may be built in or external to the mobile terminal 100. The wireless internet module 113 may be configured to transmit/receive a wireless signal in a communication network according to wireless internet technologies.

The wireless internet technology may include Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A) and the wireless internet module 113 transmits/receives data according at least one wireless internet technology including internet technology not listed above.

From the viewpoint that wireless internet access by WiBro, HSDPA, HSUPA, GSM, CDMA, WCDMA, LTE, and LTE-A is achieved through a mobile communication network, the wireless internet module 113 performing wireless internet access through the mobile communication network may be understood as one type of the mobile communication module 112.

The short-range communication module 114 may support short-range communication by using at least one of Bluetooth™, Radio Frequency Identification (RFID), Infrared Data Association (IrDA), Ultra-Wideband (UWB), ZigBee, Near Field Communication (NFC), Wireless-Fidelity (Wi-Fi), Wi-Fi Direct, and Wireless Universal Serial Bus (USB) technologies. The short-range communication module 114 may support wireless communication between the mobile terminal 100 and a wireless communication system, between the mobile terminal 100 and another mobile terminal 100, or between the mobile terminal 100 and networks including another mobile terminal 100 (or an external server) through wireless area networks. The wireless area networks may be wireless personal area networks.

Here, the other mobile terminal 100 may be a wearable device (for example, a smart watch, a smart glass, and an HMD) that is capable of exchanging data (or interworking) with the mobile terminal 100. The short-range communication module 114 may detect (or recognize) a wearable device around the mobile terminal 100, which is capable of communicating with the mobile terminal 100 In some implementations, if the detected wearable device is a device authenticated to communicate with the mobile terminal 100, the control unit 180 may transmit at least part of data processed in the mobile terminal 100 to the wearable device through the short-range communication module 114. Accordingly, a user of the wearable device may use the data processed in the mobile terminal 100 through the wearable device. For example, according thereto, when a call is received by the mobile terminal 100, a user may perform a phone call through the wearable device or when a message is received by the mobile terminal 100, a user may check the received message through the wearable device.

The location information module 115 is a module for obtaining the location (or the current location) of a mobile terminal and its representative examples include a global positioning system (GPS) module or a Wi-Fi module. For example, the mobile terminal may obtain its position by using a signal transmitted from a GPS satellite through the GPS module. As another example, the mobile terminal may obtain its position on the basis of information of a wireless access point (AP) transmitting/receiving a wireless signal to/from the Wi-Fi module, through the Wi-Fi module. If necessary, the position information module 115 may perform a function of another module in the wireless communication unit 110 in order to obtain data on the location of the mobile terminal substitutionally or additionally. The location information module 115 is a module for obtaining the position (or the current position) of the mobile terminal and is not limited to a module directly calculating and obtaining the position of the mobile terminal.

Then, the input unit 120 is used for inputting image information (or signal), audio information (or signal), data, or information inputted from a user and the mobile terminal 100 may include at least one camera 121 in order for inputting image information. The camera 121 processes image frames such as a still image or a video obtained by an image sensor in a video call mode or a capturing mode. The processed image frame may be displayed on the display unit 151 or stored in the memory 170. In some implementations, a plurality of cameras 121 equipped in the mobile terminal 100 may be arranged in a matrix structure and through the camera 121 having such a matrix structure, a plurality of image information having various angles or focuses may be inputted to the mobile terminal 100. In some implementations, the plurality of cameras 121 may be arranged in a stereo structure to obtain the left and right images for implementing a three-dimensional image.

The microphone 122 processes external sound signals as electrical voice data. The processed voice data may be utilized variously according to a function (or an application program being executed) being performed in the mobile terminal 100. In some implementations, various noise canceling algorithms for removing noise occurring during the reception of external sound signals may be implemented in the microphone 122.

The user input unit 123 is to receive information from a user and when information is inputted through the user input unit 123, the control unit 180 may control an operation of the mobile terminal 100 to correspond to the inputted information. The user input unit 123 may include a mechanical input means (or a mechanical key, for example, a button, a dome switch, a jog wheel, and a jog switch at the front, back or side of the mobile terminal 100) and a touch type input means. As one example, a touch type input means may include a virtual key, a soft key, or a visual key, which is displayed on a touch screen through software processing or may include a touch key disposed at a portion other than the touch screen. In some implementations, the virtual key or visual key may have various forms and may be displayed on a touch screen and for example, may include graphic, text, icon, video, or a combination thereof.

In some implementations, the sensing unit 140 may sense at least one of information in a mobile terminal, environmental information around a mobile terminal, and user information and may then generate a sensing signal corresponding thereto. On the basis of such a sensing signal, the control unit 180 may control the drive or control of the mobile terminal 100 or may perform data processing, functions, or operations relating to an application program installed in the mobile terminal 100. Representative sensors among various sensors included in the sensing unit 140 will be described in more detail.

First, the proximity sensor 141 refers to a sensor detecting whether there is an object approaching a predetermined detection surface or whether there is an object around by using the strength of an electromagnetic field or infrared, without mechanical contact. The proximity sensor 141 may disposed in an inner area of a mobile terminal surrounded by the touch screen or around the touch screen.

Examples of the proximity sensor 141 may include a transmission-type photoelectric sensor, a direct reflective-type photoelectric sensor, a mirror reflective-type photoelectric sensor, a high-frequency oscillation-type proximity sensor, a capacitive-type proximity sensors, a magnetic-type proximity sensor, and an infrared proximity sensor. If the touch screen is a capacitive type, the proximity sensor 141 may be configured to detect the proximity of an object by changes in an electric field according to the proximity of the object having conductivity. In some implementations, the touch screen (or a touch sensor) itself may be classified as a proximity sensor.

In some implementations, for convenience of description, an action for recognizing the position of an object on the touch screen as the object is close to the touch screen without contacting the touch screen is called “proximity touch” and an action that the object actually contacts the touch screen is called “contact touch”. A position that an object is proximity-touched on the touch screen is a position that the object vertically corresponds to the touch screen when the object is proximity-touched. The proximity sensor 141 may detect a proximity touch and a proximity touch pattern (for example, a proximity touch distance, a proximity touch direction, a proximity touch speed, a proximity touch time, a proximity touch position, and a proximity touch movement state). In some implementations, the control unit 180 processes data (for information) corresponding to a proximity touch operation and a proximity touch pattern, detected through the proximity sensor 141, and furthermore, may output visual information corresponding to the processed data on the touch screen. In some implementations, according to whether a touch for the same point on the touch screen is a proximity touch or a contact touch, the control unit 180 may control the mobile terminal 100 to process different operations or data (or information).

The touch sensor detects a touch (or a touch input) applied to the touch screen (or the display unit 151) by using at least one of various touch methods, for example, a resistive film method, a capacitive method, an infrared method, an ultrasonic method, and a magnetic field method.

For example, the touch sensor may be configured to convert a pressure applied to a specific portion of the touch screen or changes in capacitance occurring at a specific portion into electrical input signals. The touch sensor may be configured to detect a position and area that a touch target applying a touch on the touch screen touches the touch sensor, a pressured when touched, and a capacitance when touched. Here, the touch target, as an object applying a touch on the touch sensor, may be a finger, a touch pen, a stylus pen, or a pointer, for example.

In such a manner, when there is a touch input on the touch sensor, signal(s) corresponding thereto are sent to a touch controller. The touch controller processes the signal(s) and then transmits corresponding data to the control unit 180. Therefore, the control unit 180 may recognize which area of the display unit 151 is touched. Herein, the touch controller may be an additional component separated from the control unit 180 or may be the control unit 180 itself.

In some implementations, the control unit 180 may perform different controls or the same control according to types of a touch target touching the touch screen (or a touch key equipped separated from the touch screen). Whether to perform different controls or the same control according to types of a touch target may be determined according to a current operation state of the mobile terminal 100 or an application program in execution.

In some implementations, the above-mentioned touch sensor and proximity sensor are provided separately or combined and may thus sense various types of touches, for example, short (or tap) touch, long touch, multi touch, drag touch, flick touch, pinch-in touch, pinch-out touch, swipe touch, and hovering touch for the touch screen.

The ultrasonic sensor may recognize position information of a detection target by using ultrasonic waves. In some implementations, the control unit 180 may calculate the position of a wave source through information detected by an optical sensor and a plurality of ultrasonic sensors. The position of the wave source may be calculated by using the property that light is much faster than ultrasonic wave, that is, a time that light reaches an optical sensor is much shorter than a time that ultrasonic wave reaches an ultrasonic sensor. In more detail, the position of the wave source may be calculated by using a time difference with a time that ultrasonic wave reaches by using light as a reference signal.

In some implementations, the camera 121 described as a configuration of the input unit 120 may include at least one of a camera sensor (for example, CCD and CMOS), a photo sensor (or an image sensor), and a laser sensor.

The camera 121 and the laser sensor may be combined to detect a touch of a detection target for a three-dimensional image. The photo sensor may be stacked on a display element and is configured to scan a movement of a detection target close to the touch screen. In more detail, the photo sensor mounts a photo diode and a transistor (TR) in a row/column and scans content disposed on the photo sensor by using an electrical signal changing according to an amount of light applied to the photo diode. That is, the photo sensor may calculate the coordinates of a detection target according to the amount of change in light and through this, may obtain the position information of the detection target.

The display unit 151 may display (output) information processed in the mobile terminal 100. For example, the display unit 151 may display execution screen information of an application program running on the mobile terminal 100 or user interface (UI) and graphic user interface (GUI) information according to such execution screen information.

In some implementations, the display unit 151 may be configured as a three-dimensional display unit displaying a three-dimensional image.

A three-dimensional display method, for example, a stereoscopic method (a glasses method), an autostereoscopic (no glasses method), a projection method (a holographic method) may be applied to the three-dimensional display unit

In general, a 3D image includes a left image (for example, an image for the left eye) and a right image (for example, an image for the right eye). Depending on a method of combining a left image and a right image into a 3D image, the method includes a top-down method of disposing a left image and a right vertically in one frame, a left-to-right (or side by side) method of disposing a lift image and a right image horizontally in one frame, a checker board method of disposing pieces of a left image and a right image in a tile form, an interlaced method of disposing a left image and a right image in a column unit or a row unit alternately, and a time sequential (or frame by frame) method of displaying a left image and a right image alternately at each time.

In some implementations, a 3D thumbnail image may generate a left image thumbnail and a right image thumbnail respectively from the left image and the right image of an original image frame, and as they are combined, one image may be generated. In general a thumbnail means a reduced image or a reduced still image. The left image thumbnail and the right image thumbnail, generated in such a way, are displayed with a left and right distance difference on a screen by a depth corresponding to a time difference of a left image and a right image, and thereby express three-dimensional depth.

A left image and a right image, necessary for the implantation of a 3D image may be displayed on a 3D display unit through a 3D processing unit. The 3D processing unit receives a 3D image (that is, an image at a reference time point and an image at an extended time point) and sets a left image and a right image by using it, or receives a 2D image and switches it into a left image and a right image.

The sound output unit 152 may output audio data received from the wireless communication unit 110 or stored in the memory 170 in a call signal reception or call mode, a recording mode, a voice recognition mode, or a broadcast reception mode. The sound output unit 152 may output a sound signal relating to a function (for example, a call signal reception sound and a message reception sound) performed by the mobile terminal 100. The sound output unit 152 may include a receiver, a speaker, and a buzzer.

The haptic module 153 generates various haptic effects that a user can feel. A representative example of a haptic effect that the haptic module 153 generates is vibration. The intensity and pattern of vibration generated by the haptic module 153 may be controlled by a user's selection or a setting of a control unit. For example, the haptic module 153 may synthesize and output different vibrations or output different vibrations sequentially.

The haptic module 153 may generate various haptic effects, for example, effects by a pin arrangement moving vertical to a contact skin surface, injection power or suction power of air through an injection port or a suction port, rubbing a skin surface, electrode contact, stimulus of electrostatic force and effects by the reproduction of cold/warm sense by using a element absorbing or emitting heat.

The haptic module 153 may be implemented to deliver a haptic effect through a direct contact and also allow a user to feel a haptic effect through a muscle sense such as a finger or an arm. The haptic module 153 may be more than two according to a configuration aspect of the mobile terminal 100.

The optical output unit 154 outputs a signal for notifying event occurrence by using light of a light source of the mobile terminal 100. An example of an event occurring in the mobile terminal 100 includes message reception, call signal reception, missed calls, alarm, schedule notification, e-mail reception, and information reception through an application.

A signal outputted from the optical output unit 154 is implemented as a mobile terminal emits single color of multi-color to the front or the back. The signal output may be terminated when a mobile terminal detects user's event confirmation.

The interface unit 160 may serve as a path to all external devices connected to the mobile terminal 100. The interface unit 160 may receive data from an external device, receive power and deliver it to each component in the mobile terminal 100, or transmit data in the mobile terminal 100 to an external device. For example, the interface unit 160 may include a wired/wireless headset port, an external charger port, a wired/wireless data port, a memory card port, a port connecting a device equipped with an identification module, an audio I/O port, a video I/O port, and an earphone port.

In some implementations, the identification module, as a chip storing various information for authenticating usage authority of the mobile terminal 100, may include a user identity module (UIM), a subscriber identity module (SIM), and a universal subscriber identity module (USIM). A device equipped with an identification module (hereinafter referred to as an identification device) may be manufactured in a smart card form. Accordingly, the identification device may be connected to the terminal 100 through the interface unit 160.

In some implementations, when the mobile terminal 100 is connected to an external cradle, the interface unit 160 may become a path through which power of the cradle is supplied to the mobile terminal 100 or a path through which various command signals inputted from the cradle are delivered to the mobile terminal 100 by a user. The various command signals or the power inputted from the cradle may operate as a signal for recognizing that the mobile terminal 100 is accurately mounted on the cradle.

The memory 170 may store a program for an operation of the control unit 180 and may temporarily store input/output data (for example, a phone book, a message, a still image, and a video). The memory 170 may store data on various patterns of vibrations and sounds outputted during a touch input on the touch screen.

The memory 170 may include at least one type of storage medium among flash memory type, hard disk type, Solid State Disk (SSD) type, Silicon Disk Drive (SDD) type, multimedia card micro type, card type memory (for example, SD or XD memory type), random access memory (RAM) type, static random access memory (SRAM) type, read-only memory (ROM) type, electrically erasable programmable read-only memory (EEPROM) type, programmable read-only memory (PROM) type, magnetic memory type, magnetic disk type, and optical disk type. The mobile terminal 100 may operate in relation to a web storage performing a storage function of the memory 170 on internet.

In some implementations, as mentioned above, the control unit 180 may control operations relating to an application program and overall operations of the mobile terminal 100 in general. For example, if a state of the mobile terminal 100 satisfies set conditions, the control unit 180 may execute or release a lock state limiting an input of a control command of a user for applications.

In some implementations, the control unit 180 may perform a control or processing relating to a voice call, data communication, and a video call may perform pattern recognition processing for recognizing handwriting input or drawing input on the touch screen as a text and an image, respectively. In some implementations, the control unit 180 may use at least one or a combination of the above components to perform a control in order to implement various implementations described below on the mobile terminal 100.

The power supply unit 190 may receive external power or internal power under a control of the control unit 180 and may then supply power necessary for an operation of each component. The power supply unit 190 includes a battery. The battery is a rechargeable built-in battery and may be detachably coupled to a terminal body in order for charging.

In some implementations, the power supply unit 190 may include a connection port and the connection port may be configured as one example of the interface unit 160 to which an external charger supplying power for charging of the battery is electrically connected.

As another example, the power supply unit 190 may be configured to charge a battery through a wireless method without using the connection port. In some implementations, the power supply unit 190 may receive power from an external wireless power transmission device through at least one of an inductive coupling method based on a magnetic induction phenomenon, and a magnetic resonance coupling method based on an electromagnetic resonance phenomenon.

In some implementations, various implementations below may be implemented in a computer or device similar thereto readable medium by using software, hardware, or a combination thereof.

Then, a communication system using the mobile terminal 100 is described.

First, the communication system may use different wireless interfaces and/or physical layers. For example, a wireless interface available to the communication system may include Frequency Division Multiple Access (FDMA), Time Division Multiple Access (TDMA), Code Division Multiple Access (CDMA), and Universal Mobile Telecommunications Systems (UMTS) (especially, Long Term Evolution (LTE), Long Term Evolution-Advanced (LTE-A), and Global System for Mobile Communications (GSM)).

Hereinafter, for convenience of description, description is made limited to CDMA. However, it is apparent that the subject matter described in this application is applicable to all communication systems including Orthogonal Frequency Division Multiplexing (OFDM) wireless communication systems in addition to CDMA wireless communication systems.

The CDMA wireless communication system may include at least one terminal 100, at least one base station (BS) (it may be referred to as Node B or Evolved Node B), at least one base station controllers (BSCs), and a mobile switching center (MSC). MSC may be configured to be connected to Public Switched Telephone Network (PSTN) and BSCs. BSCs may be connected being paired with a BS through a backhaul line. The backhaul line may be provided according to at least one of E1/T1, ATM, IP, PPP, Frame Relay, HDSL, ADSL, and xDSL. Accordingly, a plurality of BSCs may be included in a CDMA wireless communication system.

Each of a plurality of BSs may include at least one sector and each sector may include an omni-directional antenna or an antenna indicating a specific radial direction from a BS. In some implementations, each sector may include at least two antennas in various forms. Each BS may be configured to support a plurality of frequency allocations and each of the plurality of frequency allocations may have a specific spectrum (for example, 1.25 MHz, 5 MHz, and so on).

The intersection of a sector and a frequency allocation may be referred to as a CDMA channel. A BS may be referred to as a Base Station Transceiver Subsystem (BTS). In such a case, one BSC and at least one BS together may be referred to as “BS”. A BS may also represent “cell site”. In some implementations, each of a plurality of sectors for a specific BS may be referred to as a plurality of cell sites.

A Broadcasting Transmitter (BT) transmits broadcast signals to the terminals 100 operating in a system. The broadcast reception module 111 shown in FIG. 1 is provided in the terminal 100 for receiving broadcast signals transmitted from the BT.

In some implementations, GPS may be linked to a CDMA wireless communication system in order to check the location of the mobile terminal 100. Then, a satellite helps obtaining the location of the mobile terminal 100. Useful location information may be obtained by at least one satellite. Herein, the location of the mobile terminal 100 may be traced by using all techniques for tracing the location in addition to GPS tracking technique. In some implementations, at least one GPS satellite may be responsible for satellite DMB transmission selectively or additionally.

The location information module 115 in a mobile terminal is for detecting and calculating the position of the mobile terminal and its representative example may include a GPS module and a WiFi module. If necessary, the position information module 115 may perform a function of another module in the wireless communication unit 110 in order to obtain data on the location of the mobile terminal substitutionally or additionally.

The GPS module 115 may calculate information on a distance from at least three satellites and accurate time information and then apply triangulation to the calculated information, in order to accurately calculate the 3D current location information according to latitude, longitude, and altitude. A method for calculating location and time information by using three satellites and correcting errors of the calculated location and time information by using another one satellite is being widely used. In some implementations, the GPS module 115 may calculate speed information as continuously calculating the current location in real time. However, it is difficult to accurately measure the location of a mobile terminal by using a GPS module in a shadow area of a satellite signal such as a room. Accordingly, in order to compensate for the measurement of a GPS method, a WiFi Positioning System (WPS) may be utilized.

WPS is a technique for tracking the location of the mobile terminal 100 by using a WiFi module in the mobile terminal 100 and a wireless Access Point (AP) for transmitting or receiving wireless signals to or from the WiFi module and may mean a Wireless Local Area Network (WLAN) based location measurement technique using WiFi.

A WiFi location tracking system may include a WiFi location measurement server, a mobile terminal 100, a wireless AP connected to the mobile terminal 100, and a database for storing arbitrary wireless AP information.

The mobile terminal 100 in access to a wireless AP may transmit a location information request message to a WiFi location measurement server.

The WiFi location measurement server extracts information of a wireless AP connected to the mobile terminal 100 on the basis of a location information request message (or signal) of the mobile terminal 100. Information of a wireless AP connected to the mobile terminal 100 may be transmitted to the WiFi location measurement server through the mobile terminal 100 or may be transmitted from a wireless AP to a WiFi location measurement server.

Based on the location information request message of the mobile terminal 100, the extracted information of a wireless AP may be at least one of MAC Address, Service Set Identification (SSID), Received Signal Strength Indicator (RSSI), Reference Signal Received Power (RSRP), Reference Signal Received Quality (RSRQ), channel information, Privacy, Network Type, Signal Strength, and Noise Strength.

As mentioned above, the WiFi position measurement server may extract wireless AP information corresponding to a wireless AP that the mobile terminal 100 access from a pre-established database by receiving information of the wireless AP connected to the mobile terminal 100. At this point, information of arbitrary wireless APs stored in the database may information such as MAC Address, SSID, channel information, Privacy, Network Type, latitude and longitude coordinates of a wireless AP, a building name where a wireless AP is located, the number of floors, indoor detailed location information (GPS coordinates available), the address of the owner of an AP, and phone numbers. At this point, in order to remove a mobile AP or a wireless AP provided using illegal MAC address during a measurement process, a WiFi location measurement server may extract only a predetermined number of wireless AP information in high RSSI order.

Then, the WiFi location measurement server may extract (or analyze) the location information of the mobile terminal 100 by using at least one wireless AP information extracted from the database. By comparing the included information and the received wireless AP information, location information of the mobile terminal 100 is extracted (or analyzed).

As a method of extracting (or analyzing) the location information of the motile terminal 100, a Cell-ID method, a finger-print method, a triangulation method, and a landmark method may be used.

The Cell-ID method is a method for determining the location of a wireless AP having the strongest signal intensity in neighbor wireless AP information that a mobile terminal collects as the location of the mobile terminal. No additional cost is required, and location information is obtained quickly but when the installation density of wireless APs is low, measurement precision is poor.

The finger-print method is a method for collecting signal intensity information by selecting a reference location from a service area and estimating the location through signal intensity information transmitted from a mobile terminal on the basis of the collected information. In order to use the finger-print method, there is a need to provide a database for storing propagation characteristics in advance.

The triangulation method is a method for calculating the location of a mobile terminal on the basis of a distance between coordinates of at least three wireless APs and a mobile terminal. In order to measure a distance between a mobile terminal and a wireless AP, a signal intensity converted into distance information, Time of Arrival (ToA), Time Difference of Arrival (TDoA), and Angle of Arrival (AoA) may be used.

The landmark method is a method for measuring the location of a mobile terminal by using a landmark transmitter knowing the location.

In addition to the listed methods, a variety of algorithms may be utilized as methods for extracting (or analyzing) the location information of a mobile terminal.

As the extracted location information of the mobile terminal 100 is transmitted to the mobile terminal 100 through the WiFi location measurement server, the mobile terminal 100 may obtain the location information.

As connected to at least one wireless AP, the mobile terminal 100 may obtain location information. At this point, the number of wireless APs, which are required for obtaining the location information of the mobile terminal 100, may vary according to a wireless communication environment where the mobile terminal 100 is located.

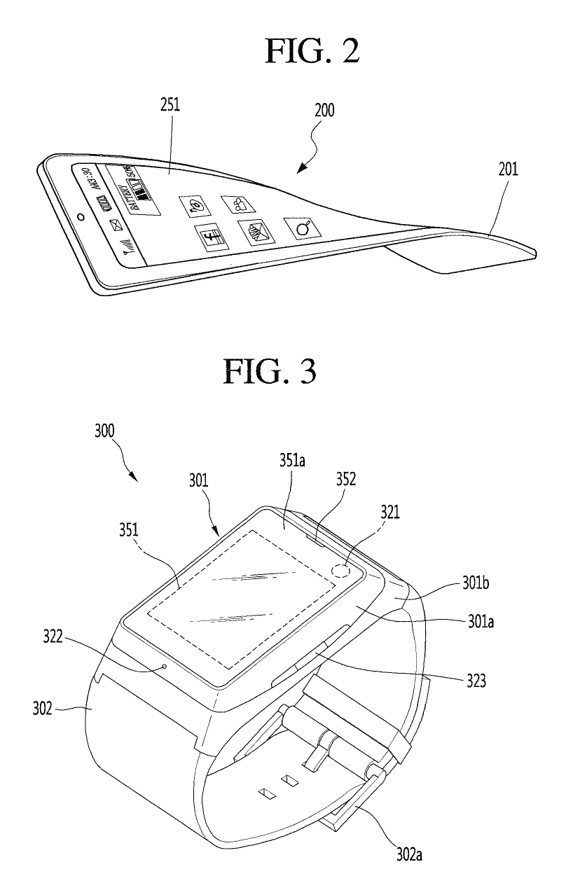

FIG. 2 illustrates an example transformable mobile terminal 200.

As shown in the drawing, a display unit 251 may be transformed by external force. The transformation may be at least one of warping, bending, folding, twisting, and curling of the display unit 251. In some implementations, the transformable display unit 251 may be referred to as a flexible display. Herein, the flexible display unit 251 may include a general flexible display, an e-paper, and a combination thereof. In general, the mobile terminal 200 may have the same or similar features to the mobile terminal of FIG. 1.

The general flexible display is a light and durable display maintaining the feature of an existing flat panel display and manufactured on a thin flexible substrate where warping, bending, folding, twisting, and curling are possible, such as paper.

In some implementations, the e-paper uses a display technique applying the feature of a general ink and is different from an existing flat panel display in that it uses reflected light. The e-paper may change information by using electrophoresis with a twist ball or a capsule.

When the flexible display unit 251 is not transformed (for example, a state having an infinite curvature radius, hereinafter referred to as a first state), the display area of the flexible display unit 251 becomes flat. When the flexible display unit 251 is transformed by external force in the first state (for example, a state having a finite curvature radius, hereinafter referred to as a second state), the display area of the flexible display unit 251 becomes a curved surface. As shown in the drawing, information displayed in the second state may be visual information outputted on the curved surface. Such visual information may be implemented by independently controlling the light emission of a sub-pixel disposed in a matrix. The sub-pixel means a minimum unit for implementing one color.

The flexible display unit 251 may be in a warping state (for example, a vertically or horizontally warped state) instead of a flat state during the first state. In some implementations, when external force is applied to the flexible display unit 251, the flexible display unit 251 may be transformed into a flat state (or a less warped state) or a more warped state.

In some implementations, the flexible display unit 251 may be combined with a touch sensor to implement a flexible touch screen. When a touch is made on the flexible touch screen, the control unit 180 of FIG. 1 may perform a control corresponding to such a touch input. The flexible touch screen may be configured to detect a touch input in both the first state and the second state.

In some implementations, the mobile terminal 200 may include a transformation detection means for detecting the transformation of the flexible display unit 251. Such a transformation detection means may be included in the sensing unit 140 of FIG. 1.

The transformation detection means may be provided at the flexible display unit 251 or the case 201, so that it may detect information relating to the transformation of the flexible display unit 251. Herein, the information relating to transformation may include a direction in which the flexible display unit 251 is transformed, the degree of transformation, a position where the flexible display unit 251 is transformed, a time that the flexible display unit 251 is transformed, and a restoring acceleration of the flexible display unit 251 and may further include various detectable information due to the warping of the flexible display unit 251.

In some implementations, on the basis of information relating to the transformation of the flexible display unit 251 detected by the transformation detection means, the control unit 180 may change the information displayed on the display unit 251 or may generate a control signal for controlling a function of the mobile terminal 200.

In some implementations, the mobile terminal 200 may include a case 201 for accommodating the flexible display unit 251. The case 201 may be configured to be transformed together with the flexible display unit 251 by external force in consideration of characteristics of the flexible display unit 251.

In some implementations, a battery equipped in the mobile terminal 200 may be configured to be transformed together with the flexible display unit 251 by external force in consideration of characteristics of the flexible display unit 251. In order to implement the battery, a stack and folding method for stacking up battery cells may be applied.

A transformed state of the flexible display unit 251 is not limited to external force. For example, when the flexible display unit 251 has the first state, it is transformed into the second state by a command of a user or an application.

In some implementations, a mobile terminal may expand to a wearable device that can be worn on the body beyond the level that a user mainly grabs the mobile terminal by a hand. Such a wearable device may include a smart watch, a smart glass, and an HMD. Hereinafter, examples of a mobile terminal expanding to a wearable device are described.

The wearable device may exchange data (or interoperate) with another mobile terminal 100. The short-range communication module 114 may detect (or recognize) a wearable device around the mobile terminal 100, which is capable of communicating with the mobile terminal 100. In some implementations, if the detected wearable device is a device authenticated to communicate with the mobile terminal 100, the control unit 180 may transmit at least part of data processed in the mobile terminal 100 to the wearable device through the short-range communication module 114. Accordingly, a user may use the data processed in the mobile terminal 100 through the wearable device. For example, when a call is received by the mobile terminal 100, a user may perform a phone call through the wearable device or when a message is received by the mobile terminal 100, a user may check the received message through the wearable device.

FIG. 3 is illustrates an example watch type mobile terminal 300.

Referring to FIG. 3, the watch type mobile terminal 300 includes a body 301 including a display unit 351 and a band 302 connected to the body 301 to be worn on a wrist. In general, the mobile terminal 300 may have the same or similar features to the mobile terminal of FIG. 1.

The main body 301 includes a case for forming the appearance. As shown in the drawings, the case includes a first case 301a and a second case 301b preparing an inner space that accommodates various electronic components. In some implementations, the case may be configured to prepare the inner space so that the unibody mobile terminal 300 may be implemented.

The watch type mobile terminal 300 may be configured to allow wireless communication and an antenna for the wireless communication may be installed at the body 301. In some implementations, the antenna may expand its performance by using a case. For example, a case including a conductive material may be configured to be electrically connected to an antenna in order to expand a ground area or a radiation area.

The display unit 351 is disposed at the front of the body 301 to output information and a touch sensor is equipped at the display unit 351 to be implemented as a touch screen. As shown in the drawing, a window 351a of the display unit 351 is mounted at the first case 301a to form the front of the terminal body together with the first case 301a.

The body 301 may include a sound output unit 352, a camera 321, a microphone 322, and a user input unit 323. When the display unit 351 is implemented as a touch screen, it may function as the user input unit 323 and accordingly, there is no additional key at the body 301.

The band 302 is worn on a wrist to wrap it and may be formed of a flexible material in order for easy wearing. As such an example, the band 302 may be formed of leather, rubber, silicon, and synthetic resin. In some implementations, the band 302 may be configured to be detachable from the body 301, so that it may be replaced with various forms of bands according to user preferences.

In some implementations, the band 302 may be used to expand the performance of an antenna. For example, a ground expansion unit electrically connected to an antenna to expand a ground area may be built in a band.

The band 302 may include a fastener 302a. The fastener 302a may be implemented by a buckle, a snap-fit available hook structure, or Velcro (a brand name) and may include a stretchable interval or material. This drawing illustrates an example that the fastener 302a is implemented in a buckle form.

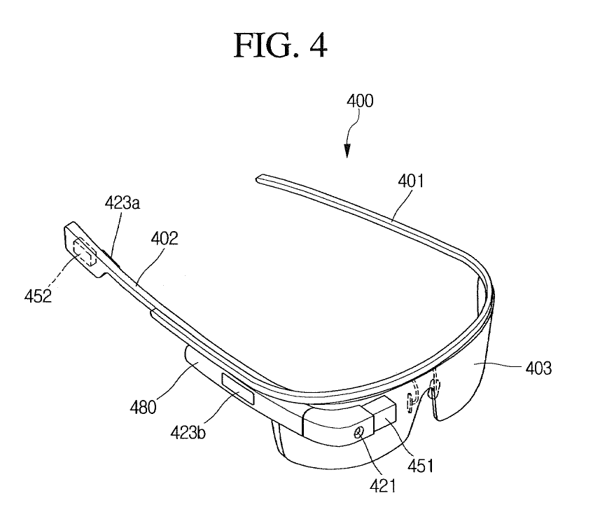

FIG. 4 illustrates an example glass type mobile terminal.

The glass type mobile terminal 400 may be configured to be worn on the head portion of a human body and for this, may include a frame part (for example, a case and a housing). The frame part may be formed of a flexible material in order for easy wearing. In this drawing, the frame part includes a first frame 401 and a second frame 402 formed of different materials. In general, the mobile terminal 400 may have the same or similar features to the mobile terminal of FIG. 1.

The frame part is supported by the head portion and provides a space for mounting various components. As shown in the drawing, electronic components such as a control module 480 and a sound output module 452 may be mounted at the frame part. In some implementations, a lens 403 covering at least one of the left eye and the right eye may be detachably mounted at the frame part.

The control module 480 may be configured to control various electronic components equipped at the mobile terminal 400. The control module 480 may be understood as a component corresponding to the above-described control unit 180. In this drawing, the control module 480 is installed at the frame part on one side of the head portion. However, the position of the control module 480 is not limited thereto.

The display unit 451 may be implemented in an HMD form. The HMD form refers to a display method for displaying an image directly in front of the user's eyes, to be worn on the head portion of the human body. When a user wears a glass type mobile terminal 400, in order to provide an image directly in front of the user's eyes, the display unit 451 may be disposed in correspondence to at least one of the left eye and the right eye. In this drawing, in order to output an image toward the user's right eye, the display unit 451 is disposed in correspondence to a portion corresponding to the right eye.

The display unit 451 may project an image to the user's eye by using a prism. In some implementations, in order to allow a user to see the projected image and a general front view (that is, a range that the user can see through the eyes), the prism may be transparent.

In such a way, an image outputted through the display unit 451 may be overlapped with a general view and displayed. The mobile terminal 400 may provide augmented reality (AR) superimposing a virtual image on a real image or a background and displaying it as one image by using characteristics of such a display.

The camera 421 is disposed adjacent to at least one of the left eye and the right eye to capture a front image. Since the camera 421 is disposed adjacent to the eye, it may obtain an image of a scene that a user sees.

In this drawing, the camera 421 is equipped at the control module 480. The camera 421 may be installed at the frame part and may be provided in plurality to obtain a three-dimensional image.

The glass type mobile terminal 400 may include user input units 423a and 423b manipulated to receive a control command. The user input units 423a and 423b may adopt any method if it is a tactile manner that a user manipulates touch and push with tactile feeling. In this drawing, the user input units 423a and 423b of a push and touch input method are equipped at the frame part and the control module 480, respectively.

In some implementations, the glass type mobile terminal 400 may include a microphone receiving sound and processing it electrical voice data and a sound output module 452 outputting sound. The sound output module 452 may be configured to deliver sound through a general sound output method or a bone conduction method. When the sound output module 452 is implemented with a bone conduction and a user wears the mobile terminal 400, the sound output module 452 closely contacts the head portion and delivers sound by vibrating the skull.

A mobile terminal may include a display unit, a sensing unit, and a control unit.

A 360-degree video may be displayed on the display unit. The 360-degree video may be a video having the angle view of 360 degrees through omni-directional capturing. Herein, the display unit may be implemented in a touch screen form.

The sensing unit may correspond to the user input unit 123 or the sensing unit 140 shown in FIG. 1. In some implementations, the sensing unit may detect an input signal from a user. The input signal from a user may include short touch, long touch, drag touch, pinch-out touch, pinch-in touch, and double-tap touch.

The control unit may display a 360-degree image on the display unit and control the sensing unit to detect an input signal on the 360-degree image.

In more detail, when a first input signal for reproducing a 360-degree image at a first viewing angle is detected, the control unit may display the first image reproduced at the first viewing angle on the display unit in correspondence thereto, and when a second input signal for reproducing the 360-degree image at a second viewing angle different from the first viewing angle is detected, display the second image reproduced at the second viewing angle on the display unit in correspondence thereto, and display a picture-in-picture (PIP) screen where a predetermined content is displayed on the second image.

User Notification for 360-Degree Image in Search Result

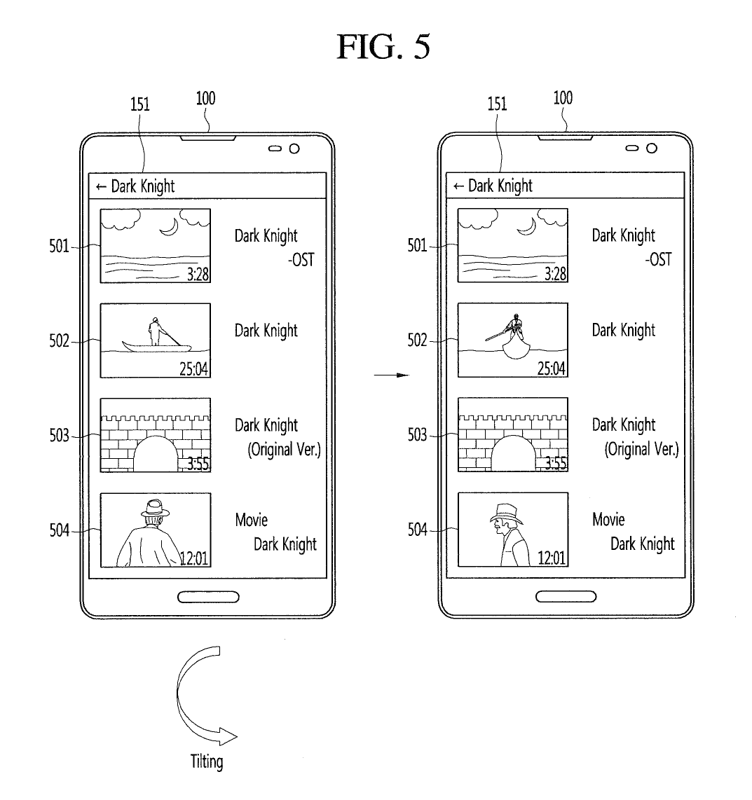

FIG. 5 illustrates an example mobile terminal that provides notification on a 360-degree image.

A mobile terminal 100 may rotate and display the thumbnail of a 360-degree image in correspondence to a tilting angle. In some implementations, the thumbnail of a general image that is not a 360-degree image is not changed.

The mobile terminal 100 may search for a plurality of images and display them on a screen. The plurality of images may be a video. When video is displayed on a screen, the mobile terminal 100 may display a still cut, which is the minimum unit of a video scene played at a predetermined time, as a thumbnail. Herein, a thumbnail may be a still cut corresponding to a predetermined viewing angle at a predetermined playback time selected by a manufacturer of a video. Hereinafter, a still cut and a thumbnail are described in the same concept.

A 360-degree image has a 360-degree viewing angle. Due to such characteristics, a 360-degree image may be reproduced at a plurality of viewing angles on the basis of a predetermined time. Accordingly, a plurality of still cuts may be generated from a 360-degree image on the basis of a predetermined time.

The viewing angel of a general image is fixed. That is, a general image may be reproduced only at a viewing angle selected by a photographer. Accordingly, only one still cut may be generated from a general image on the basis of a predetermined time.

The mobile terminal 100 may be tilted by a user. Herein, the tilting may be an operation for adjusting an angle between the mobile terminal 100 and a horizontal surface or a vertical surface. During tilting, the mobile terminal 100 may be tilted or rotated on the basis of a horizontal surface or a vertical surface. Hereinafter, an angle at which the mobile terminal 100 is tilted on the basis of a horizontal surface or a vertical surface is defined as a tilting angle.

When the mobile terminal 100 is tilted, it may rotate and display the thumbnail of a 360-degree image in correspondence to the tilting angle of the mobile terminal 100.

The rotation degree of a thumbnail may be set variously.

In some implementations, the mobile terminal 100 may rotate a thumbnail at a tilting angle and display it. For example, when the viewing angle of the currently displayed thumbnail is 60° and its tilting angle is 300, the mobile terminal 100 may rotate the viewing angle of the thumbnail to a tilting angle to display a thumbnail corresponding to the 30° viewing angle.

In some implementations, the mobile terminal 100 may rotate a thumbnail by a tilting angle from the viewing angle of the currently displayed thumbnail. For example, when the viewing angle of the currently displayed thumbnail is 60° and its tilting angle is 30°, the mobile terminal 100 may rotate by 30° from 60° to display a thumbnail corresponding to the 90° viewing angle.

When the mobile terminal 100 is tilted, it may not change the thumbnail of a general image and display the thumbnail as it is.

Referring to FIG. 5, a plurality of videos corresponding to an inputted search word are displayed as thumbnails 501, 502, 503, and 504 on the screen of the mobile terminal 100. Herein, the thumbnails 501, 502, 503, and 504 may be still cuts corresponding to a predetermined viewing angle at a predetermined playback time selected by a manufacturer of a video. In some implementations, information on a predetermined playback time may be displayed on the thumbnails 501, 502, 503, and 504.

When the mobile terminal 100 is tilted, the second thumbnail 502 and the fourth thumbnail 504 are rotated and displayed. On the other hand, the first thumbnail 501 and the third thumbnail 503 are displayed as they are. Therefrom, a user may check that the second thumbnail 502 and the fourth thumbnail 504 are 360-degree images and the first thumbnail 501 and the third thumbnail 503 are general images.

A list of found images includes general images in addition to 360-degree images. Accordingly, when wanting to search for only a 360-degree image, a user needs to search for each 360-degree image from the image list.

In some implementations, when a user tilts the mobile terminal 100, the thumbnail of a 360-degree image is moved depending on a tilting angle. Therefrom, a user may check only a 360-degree image in the found image list through the tilting of the mobile terminal 100.

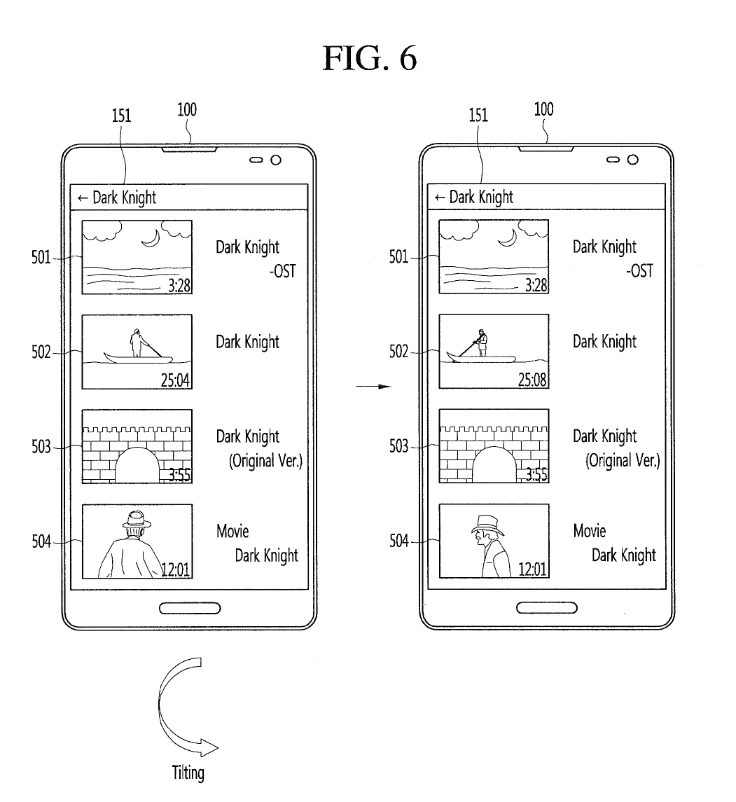

FIG. 6 illustrates an example mobile terminal that provides notification on a 360-degree image.

When the mobile terminal 100 is tilted, it may change and display a 360-degree image differently according to whether a 360-degree video is billed.

When a 360-degree image is free, the mobile terminal 100 may play the 360-degree image. In more detail, the mobile terminal 100 may start to play a 360-degree image in the currently displayed thumbnail state. The currently displayed thumbnail is a still cut corresponding to a predetermined viewing angle at a predetermined playback time. Accordingly, a 360-degree image starts to be played at the predetermined viewing angle from the predetermined playback time. In some implementations, the viewing angle is not changed.

When a 360-degree image is charged, the mobile terminal 100 may rotate and display a thumbnail in correspondence to a tilting angle. In more detail, the mobile terminal 100 may change a viewing angle in the currently displayed thumbnail state. In some implementations, a 360-degree image is not played.

In some implementations, when a 360-degree image is free, a thumbnail corresponding to a tilting angle is rotated and when a 360-degree image is charged, a 360-degree image may be played.

Referring to FIG. 6, a plurality of videos corresponding to an inputted search word are displayed as thumbnails 501, 502, 503, and 504 on the screen of the mobile terminal 100.

When the mobile terminal 100 is tilted, the second thumbnail 502 starts to be played in the currently displayed thumbnail state. Since the playback time of the currently displayed thumbnail is 25 min 04 sec, the second thumbnail 502 starts to be played from 25 min 04 sec. Thereby, a still cut in the second thumbnail 502 is changed and a playback time is changed to 25 min 08 sec.

When the mobile terminal 100 is tilted, the viewing angle of the fourth thumbnail 504 is changed in the currently displayed thumbnail state. Thereby, a still cut in the fourth thumbnail 504 is rotated. In some implementations, since the fourth thumbnail 504 is not played, a playback time is not changed.

When the mobile terminal 100 is tilted, the first thumbnail 501 and the third thumbnail 503 are displayed as they are.

Therefrom, a user may check that the second thumbnail 502 is a free 360-degree image and the fourth thumbnail 504 is a charged 360-degree image. In some implementations, a free 360-degree image may be viewed without an additional manipulation.

A 360-degree image may be divided into a free image and a charged image. In the case of a charged image, a charge for viewing is required but in the case of a free image, viewing is possible without charging.

In some implementations, when a user tilts the mobile terminal 100, a free 360-degree image starts to be played. Therefrom, a free 360-degree image may be viewed without an additional manipulation.

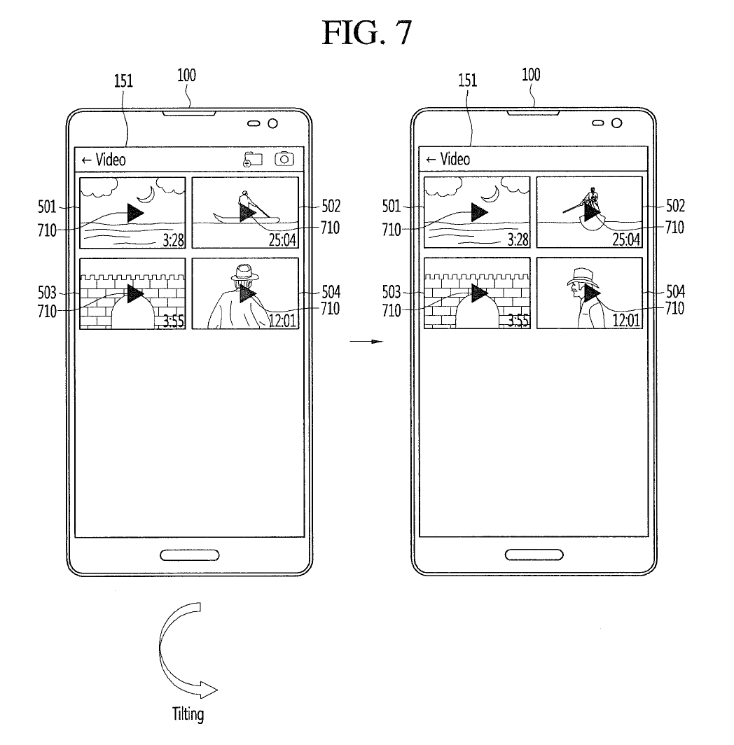

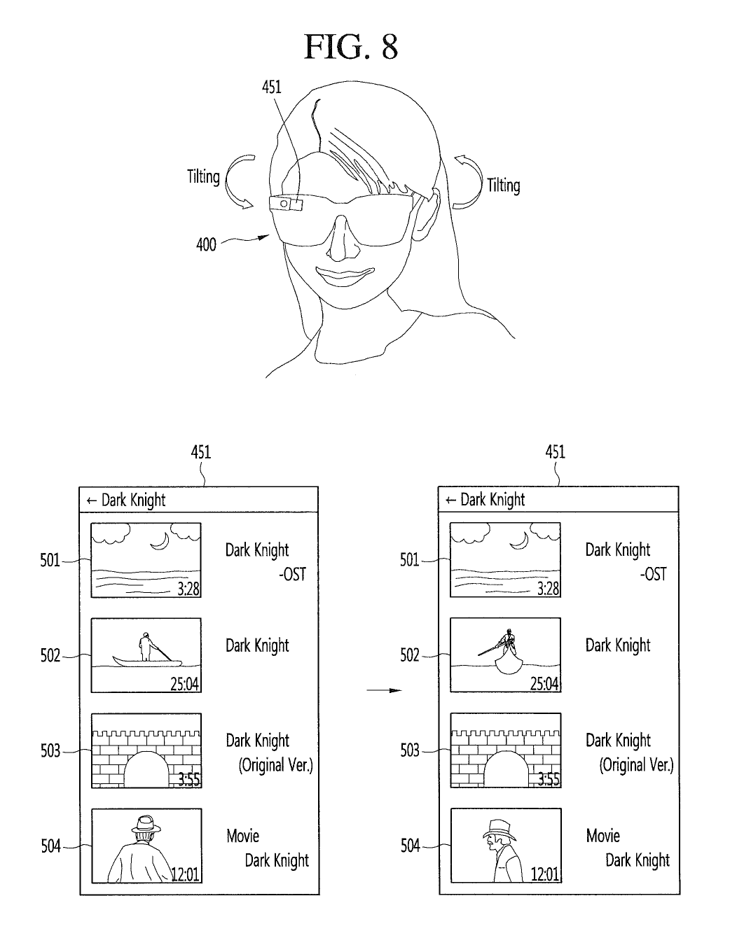

FIG. 7 illustrates an example mobile terminal that provides notification on a 360-degree image.

The mobile terminal 100 may rotate and display the thumbnail of a 360-degree image displayed on a gallery app in correspondence to a tilting angle. In some implementations, the thumbnail of a general image is not changed.

When a gallery app is executed, the mobile terminal 100 may align and display a plurality of videos on a screen. When video is displayed on a screen, the mobile terminal 100 may display a still cut, which is the minimum unit of a video scene played at a predetermined time, as a thumbnail. Herein, a thumbnail may be a still cut corresponding to a predetermined viewing angle at a predetermined playback time selected by a manufacturer of a video. A play button for playing a corresponding video may be displayed on a thumbnail.

The mobile terminal 100 may be tilted by a user. When the mobile terminal 100 is tilted, it may rotate and display the thumbnail of a 360-degree image in correspondence to the tilting angle of the mobile terminal 100. In some implementations, the mobile terminal 100 does not rotate the thumbnail of a general image and display the thumbnail as it is.

Referring to FIG. 7, a plurality of videos are displayed as thumbnails 501, 502, 503, and 504 on the gallery app screen. In some implementations, information on a predetermined playback time is displayed on the thumbnails 501, 502, 503, and 504 and a play button 710 for playing the thumbnails 501, 502, 503, and 504 is displayed thereon.

During this state, when the mobile terminal 100 is tilted, the second thumbnail 502 and the fourth thumbnail 504 are rotated and displayed. On the other hand, the first thumbnail 501 and the third thumbnail 503 are not changed and are displayed as they are. Therefrom, a user may check that the second thumbnail 502 and the fourth thumbnail 504 are 360-degree images and the first thumbnail 501 and the third thumbnail 503 are general images.

A video list stored in a gallery app includes general images in addition to 360-degree images. Accordingly, when wanting to search for only a 360-degree video, a user needs to search for each 360-degree video from the video list.

In some implementations, when a user tilts the mobile terminal 100, the thumbnail of a 360-degree image is moved depending on a tilting angle. Thereby, a user may distinguish a 360-degree image from a general image among a plurality of videos stored in a gallery app. In some implementations, based on this, a user may check only a 360-degree image from an image list stored in a gallery app.

FIG. 8 illustrates an example glass-type mobile terminal that provides notification on a 360-degree image.

The implementations described with reference to FIGS. 5 to 7 may be identically applied to a glass-type mobile terminal 400. In some implementations, the glass-type mobile terminal 400 may rotate and display the thumbnail of a 360-degree image in correspondence to a tilting angle and display the thumbnail of a general image as it is without rotating it.

A user may tilt or rotate the head while wearing the glass-type mobile terminal 400 on the head. In some implementations, the glass-type mobile terminal 400 may be tilted.

As shown in FIG. 8, a plurality of videos are displayed as thumbnails 501, 502, 503, and 504 on the display unit 451 of the glass-type mobile terminal 400. Herein, the thumbnails 501, 502, 503, and 504 may be still cuts corresponding to a predetermined viewing angle at a predetermined playback time selected by a manufacturer of a video. In some implementations, information on a predetermined playback time may be displayed on the thumbnails 501, 502, 503, and 504.

When the glass-type mobile terminal 400 is tilted, the second thumbnail 502 and the fourth thumbnail 504 are rotated. On the other hand, the first thumbnail 501 and the third thumbnail 503 are not rotated and are displayed as they are. Therefrom, a user may check that the second thumbnail 502 and the fourth thumbnail 504 are 360-degree images and the first thumbnail 501 and the third thumbnail 503 are general images.

In some implementations, when a user moves while wearing the glass-type mobile terminal 400 on the head, the thumbnail of a 360-degree is moved in correspondence to a user's movement. Therefrom, a user may distinguish a 360-degree image from a general image and furthermore, check only a 360-degree image from an image list.

Display of 360-Degree Image in Search Result

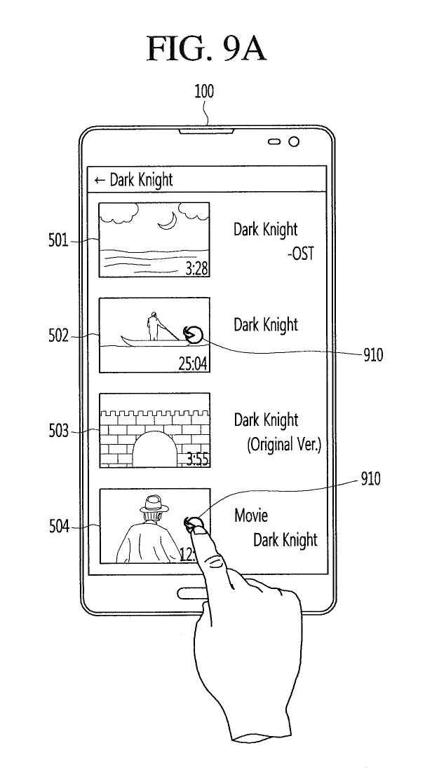

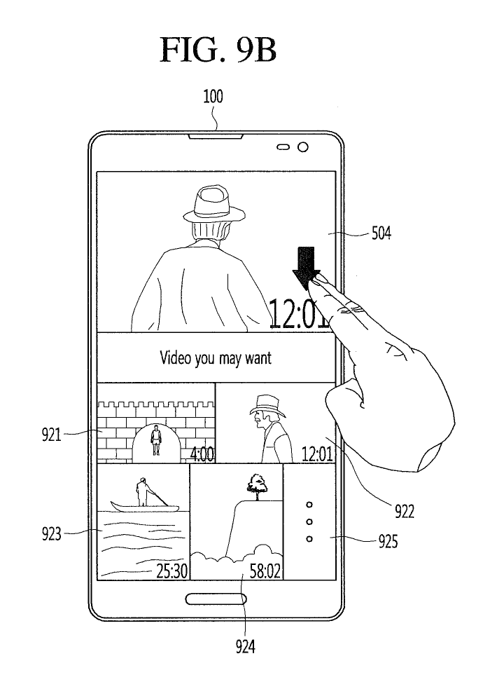

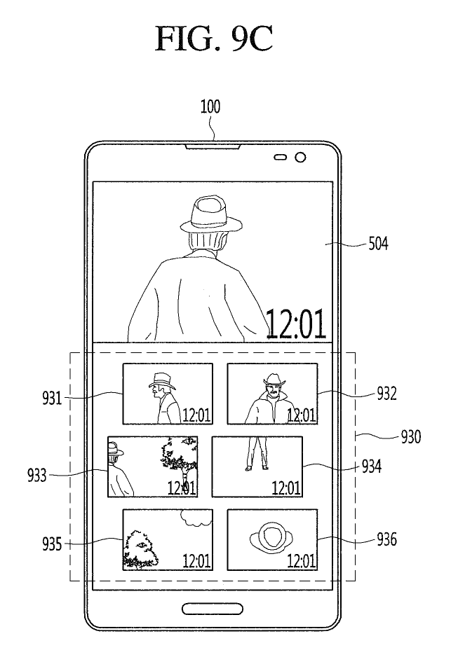

FIGS. 9A to 9C illustrate an example mobile terminal that displays a 360-degree image in a search result.

When displaying a list of a plurality of found videos on a screen, the mobile terminal 100 may display a 360-degree icon on a 360-degree image. In some implementations, a 360-degree icon is not displayed on a general image.

A 360-degree icon may be defined by an identifier for displaying a 360-degree image. In some implementations, the form of a 360-degree icon may be set variously. For example, it may be displayed in an arrow form to notify that a viewing angle is rotatable or displayed in the letter of 360 degrees to represent that a viewing angle is 360 degrees.

When a 360-degree image is displayed on a screen, the mobile terminal 100 may display a still cut of a video scene corresponding to a predetermined viewing angle at a predetermined playback time selected by a manufacturer of a video, as a thumbnail. Hereinafter, a thumbnail displayed in this case is defined as a representative thumbnail.

A 360-degree icon may be displayed in correspondence to each 360-degree image. In more detail, a 360-degree icon may be displayed in correspondence to each representative thumbnail of a 360-degree image. When a 360-degree icon is selected, the mobile terminal 100 may display a detail search result for a 360-degree image corresponding thereto.

The detail search result may include a plurality of thumbnails relating to a 360-degree image. Herein, the plurality of thumbnails may be selected based on whether viewers' recommendation frequency or search frequency and a specific object (for example, a leading actor, a specific object, and so on) are displayed. A plurality of thumbnails may be aligned and displayed according to a predetermined reference. For example, a plurality of thumbnails may be aligned and displayed in the descending order of a recommendation frequency. Hereinafter, a plurality of thumbnails displayed in this case is defined as a detail thumbnail.

When a representative thumbnail is selected, the mobile terminal 100 may display a multi view for the representative thumbnail. The multi view is defined with a still cut of a video scene played at a viewing angle different from a predetermined viewing angle of a representative thumbnail. Such a multi view may include a plurality of still cuts. An image of various viewing angles may be provided by a multi view.

Referring to FIG. 9A, a plurality of found videos are displayed as representative thumbnails 501, 502, 503, and 504 on the screen of the mobile terminal 100. In some implementations, a 360-degree icon 910 is displayed on only the second representative thumbnail 502 and the fourth representative thumbnail 504. Accordingly, the second representative thumbnail 502 and the fourth representative thumbnail 504 are 360-degree images and the first representative thumbnail 501 and the third representative thumbnail 503 correspond to general images. During this state, a 360-degree icon 910 displayed on the fourth representative thumbnail 504 is selected.

When an input signal for selecting the 360-degree icon 910 displayed on the fourth representative thumbnail 504 is detected, the mobile terminal 100 may display the detail thumbnails 921, 922, 923, and 924 of a 360-degree image corresponding to the selected 360-degree icon 910. Referring to FIG. 9B, the fourth representative thumbnail 504 of a selected 360-degree image is displayed at a screen upper end. The detail thumbnails 921, 922, 923, and 924 of a selected 360-degree image are displayed at a screen lower end.

In some implementations, a more view icon 925 is displayed on a screen. When the more view icon 925 is selected, the mobile terminal 100 may additionally display detail thumbnails of other rankings on a screen.

When scrolling down the fourth representative thumbnail 504 with two fingers contacting it, the fourth representative thumbnail 504 is selected. An operation for selecting the fourth representative thumbnail 504 may include various touches such as short (or tap) touch, long touch, multi touch, drag touch, flick touch, pinch-in touch, pinch-out touch, swipe touch, and hovering touch on the fourth representative thumbnail 504.

When the fourth representative thumbnail 504 is selected, the mobile terminal 100 displays a multi view 930 for the fourth representative thumbnail 504. Referring to FIG. 9C, the fourth representative thumbnail 504 is displayed at a screen upper end of the mobile terminal 100 and the multi view 930 for the fourth representative thumbnail 504 is displayed at a screen lower end.

The multi view 930 includes a plurality of still cuts 931, 932, 933, 934, 935, and 936. The plurality of still cuts 931, 932, 933, 934, 935, and 936 are still cuts of a video scene played at a viewing angle different from a predetermined viewing angle of the fourth representative thumbnail 504. That is, the multi view 930 may be a plurality of still cuts played with different viewing angles during a time identical to the playback time of the fourth representative thumbnail 504. By the multi view 930, images for the fourth representative thumbnails 504 viewed at various angles may be provided as thumbnails.

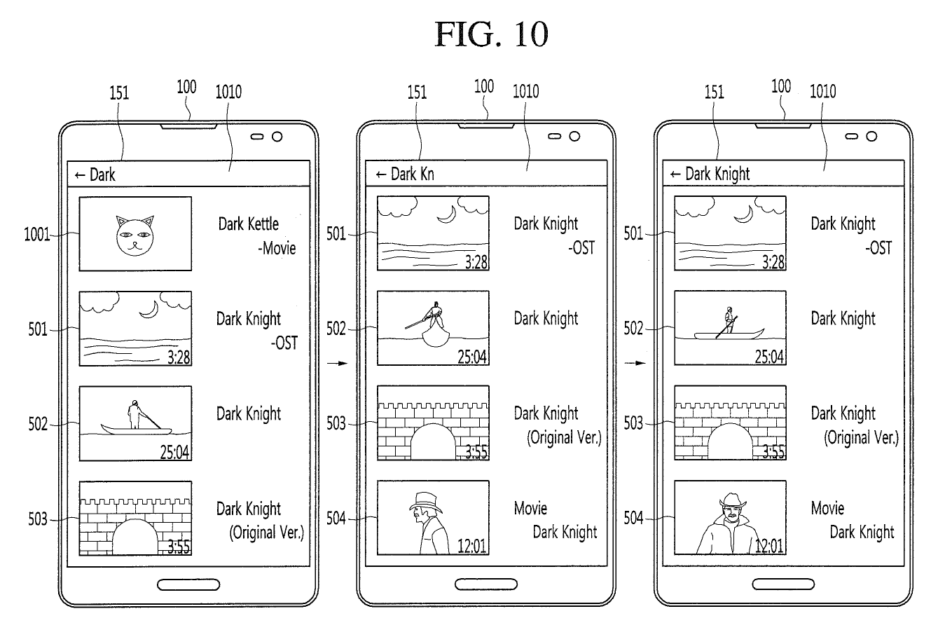

FIG. 10 illustrates an example mobile terminal that displays a 360-degree image in a search result.

When searching for videos in real time, the mobile terminal 100 may change a 360-degree image each time a search word is inputted. In more detail, each time a letter for configuring a search word is inputted, the mobile terminal 100 searches for videos in real time based on the inputted letter and each time a letter is inputted, change the viewing angle of a 360-degree image among the found videos. In some implementations, the viewing angle of a general image is not changed.

A search word for searching for videos includes a plurality of letters. Herein, the letter may be one of characters, numbers, and symbols. Accordingly, a search word may be configured with a combination of at least one of characters, numbers, and symbols.

When a user searches for videos, the mobile terminal 100 may receive a search word. In more detail, the mobile terminal 100 may receive a plurality of letters configuring a search word in the order. Thereby, a plurality of letters may be inputted in real time. The mobile terminal 100 searches for videos in real time in correspondence to a plurality of letters inputted in real time and displays a found video list.

The found video list may be changed in correspondence to an inputted letter. In more detail, when a letter is inputted in real time, a word generated by a combination of inputted letters is changed in real time. The type and order of a found video are changed according to a word. Accordingly, each time a letter configuring a search word is inputted, the found video list may be changed in real time.

Each time a letter configuring a search word is inputted, the mobile terminal 100 may change the viewing angle of a 360-degree image in real time.

Herein, a change degree of a viewing angle may be set variously. In more detail, a change degree may be set based on a predetermined viewing angle or a manufacturer intended optimal viewing angle or may be set based on a viewing angle having a high view's watching or recommendation frequency.

In some implementations, even when the viewing angle of a 360-degree image is changed in real time in correspondence to an inputted letter, the viewing angle of a general image is not changed.

Referring to FIG. 10, a user may input the letters of D, a, r, k, K, n, i, g, h, and t in the order so as to input the search word of Dark Knight.

When the letters D, a, r, and k are sequentially inputted to a search window 1010, a search word becomes Dark. In some implementations, the mobile terminal 100 searches for a list of videos 1001, 501, 502, and 503 corresponding to the inputted Dark and display it. The found video list includes the 360-degree image 502.

When the letters of Dark Kn are sequentially inputted to the search window 1010, according thereto, the search word changes into Dark kn. The mobile terminal 100 searches for a list of videos 501, 502, 503, and 504 corresponding to the inputted Dark kn and display it. Since the search word is changed, the found video list is changed. In some implementations, the viewing angle of the 360-degree image 502 in the video list is changed and displayed.

When the letters of Dark Knight are sequentially inputted to the search window 1010, the search word changes into Dark knight. The mobile terminal 100 searches for a list of videos 501, 502, 503, and 504 corresponding to the inputted Dark knight and display it. Even when the search word is changed, the found video list may not be changed. The video list is not changed in FIG. 10. However, the viewing angles of the 360-degree images 502 and 504 in the video list are changed and displayed.

In such a way, each time a search word is inputted during a real time video search, the viewing angle of a 360-degree image is changed. Thereby, a user may identify a 360-degree image in advance.

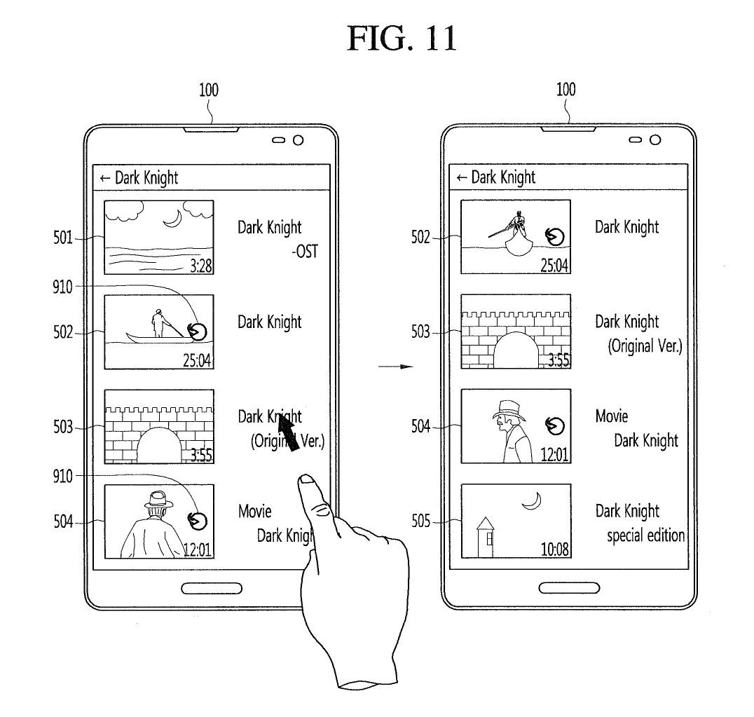

FIG. 11 illustrates an example mobile terminal that displays a 360-degree image in a search result.

When a found video list is scrolled, the mobile terminal 100 may rotate the viewing angle of a 360-degree image in correspondence to a scroll operation. In more detail, the mobile terminal 100 may scroll and display a video list and at the same time, change and display the viewing angle of a 360-degree image.

For this, the mobile terminal 100 may recognize an inputted scroll operation as an input for controlling a 360-degree image.

The scroll operation may include scroll up and scroll down. Herein, stroll up may be an operation for moving a list from bottom to top and scroll down may be an operation for moving a list from top to bottom. A list may move down by scroll up and a list may move up by scroll down.

A scroll up or scroll down operation may not be performed linearly. That is, a scroll up or scroll down operation may be performed obliquely as tilted by a predetermined angle based on a scroll direction. In some implementations, the predetermined angle is defined as a scroll angle.

When a found video list (for example, a search result list) is scrolled, the mobile terminal 100 may rotate the viewing angle of a 360-degree image included in a search result list in correspondence to a scroll angle. In some implementations, the mobile terminal 100 may rotate the viewing angle of a 360-degree image by a scroll angle or rotate the viewing angle of a 360-degree image by a scroll angle from the current viewing angle.

As shown in FIG. 11, a search result list scrolls up from a down direction to an up direction. Thereby, the search result list is moved in a down direction.

A scroll up operation is tilted by a scroll angle based on a scroll direction. Accordingly, the viewing angle of a 360-degree image in the search result list is rotated by the scroll angle. Therefore, the viewing angles of the second representative thumbnail 502 and the fourth representative thumbnail 504, that is, 360-degree images, are rotated and displayed.

Provision of Charged Image According to Viewing Angle

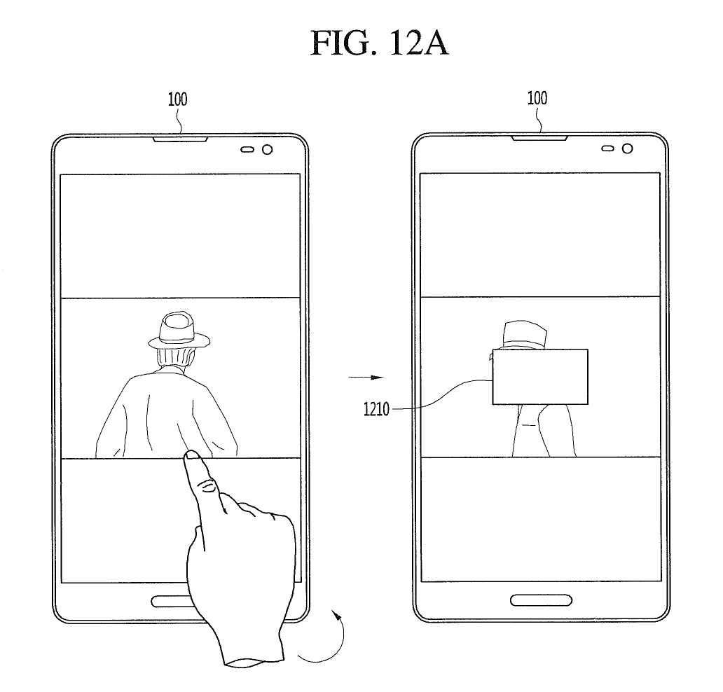

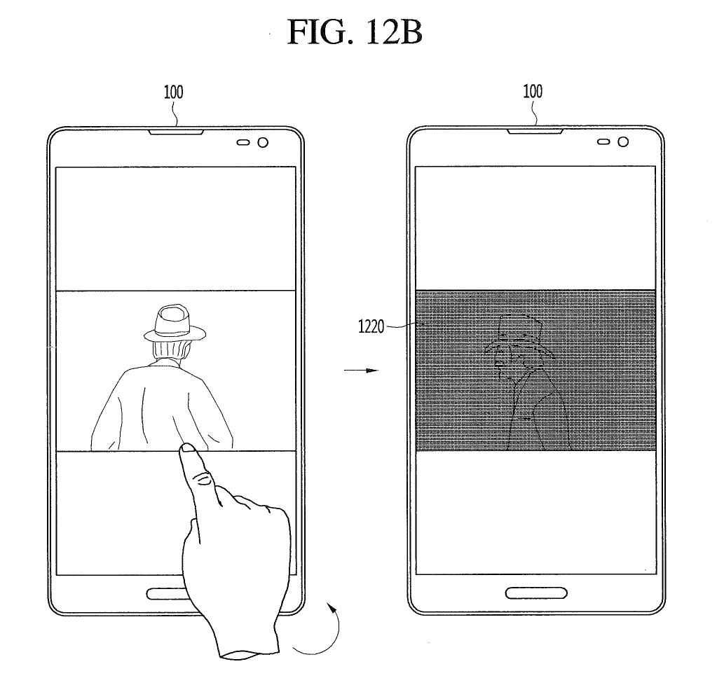

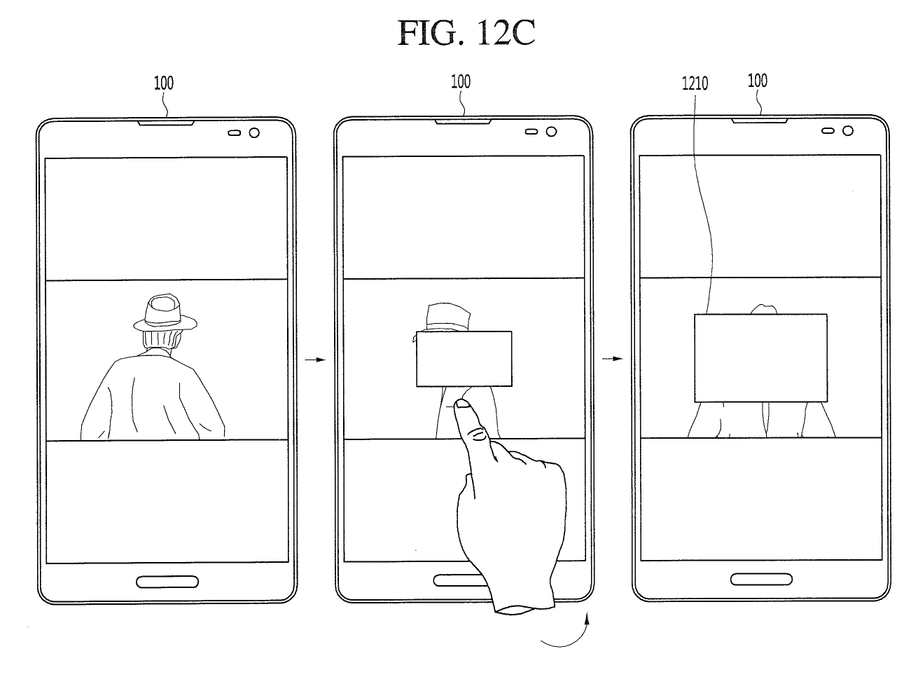

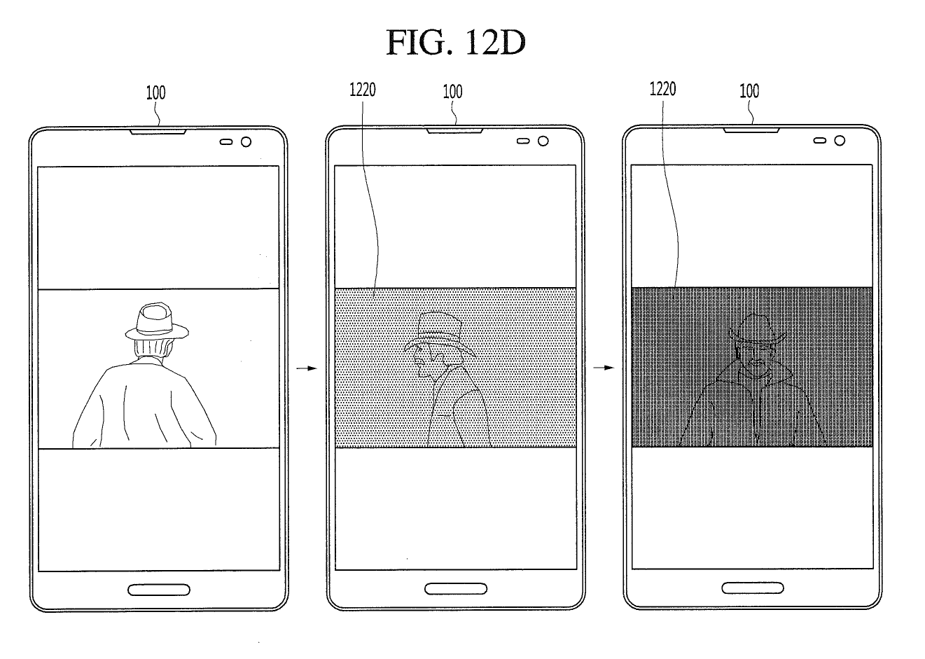

FIGS. 12A to 12D illustrate an example mobile terminal that provides a charged image depending on a viewing angle.

The mobile terminal 100 may provide a charged image according to a viewing angle. Herein, a charged image is an opposite concept to a free image. Such a charged image may include videos that require advertisement watch or information input in order for watching in addition to videos that require payment.

In some implementations, the mobile terminal 100 may provide an advertisement or payment window according to a viewing angle. The advertisement or payment window may be provided as a PIP screen. When the advertisement or payment window is provided as a PIP screen, a charged image being played or displayed in a still image form on a main screen may be paused and a PIP screen for displaying an advertisement or payment window may be displayed overlapping on the main screen. In some implementations, an advertisement or payment window may be provided on a main screen. In some implementations, a charged image being played or displayed in a still image form on a main screen may disappear from a main screen and an advertisement or payment window may be displayed.

A PIP screen where an advertisement or payment window is displayed may be displayed overlapping on the main view of a charged image. A main view for a charged image exists. The main view may be an area where a specific object including a starring actor or a specific thing is displayed or an area corresponding to the optimal viewing angle. In some implementations, the main view may be a specific area set by a manufacturer of a charged image.

In some implementations, a user needs to watch an advertisement or make a payment in order to see the main view.

Referring to FIG. 12A, a user watches a default view that is basically provided from a charged image. In this state, a user moves a screen in order to watch a main view. When a charged image is switched to a main view, a PIP screen 1210 for displaying an advertisement or payment window is displayed overlapping on the main view.

In some implementations, the mobile terminal 100 may superimpose and display a shaded area 1220 on a charged image according to a viewing angle and display a message for asking whether to move to an advertisement or payment window.

When the viewing angle of a charged image is switched to a main view, the shaded area 1220 may be displayed on the charged image.

The shaded area 1220 may be displayed overlapping on a charged image. Thereby, even when a charged image is played continuously, a user may not watch the charged image normally. A user who wants to watch a charged image may select a corresponding message to move to an advertisement or payment window.

Referring to FIG. 12B, a user watches a default view that is basically provided from a charged image. In this state, a user moves a screen in order to watch a main view. When a charged image is switched to a main view, the shaded area 1220 may be displayed overlapping on a main screen.

A message for asking whether to move an advertisement or payment window may be displayed at a lower end of the main screen. In some implementations, a user who wants to watch a charged image may select a corresponding message to move to an advertisement or payment window.

As the viewing angle of a charged image is closer to a main view, the size of the PIP screen 1210 displayed on the charged image may be enlarged and the transparency of the shaded area 1220 may be lowered. Referring to FIG. 12C, as a charged image rotates and the viewing angle is closer to a main view, the size of the PIP screen 1210 becomes larger. Referring to FIG. 12D, as a charged image rotates and the viewing angle is closer to a main view, the transparency of the shaded area 1220 becomes lower. Thereby, as a charged image is closer to a main view, it is difficult for a user to watch a 360-degree image normally.

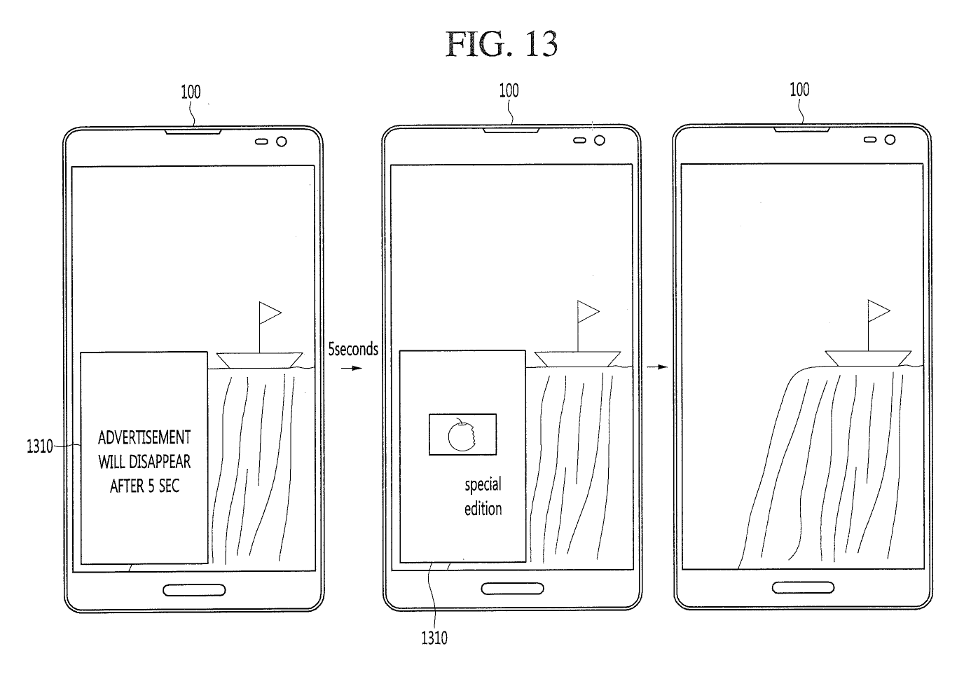

FIG. 13 illustrates an example mobile terminal that provides a charged image depending on a viewing angle.

The mobile terminal 100 may display an advertisement in a specific area and after a corresponding advertisement is displayed for more than a predetermined time, terminate the corresponding advertisement and play a charged image.

When a charged image is selected, an advertisement guide message may be displayed. The advertisement guide message may include the content that an advertisement starts soon and disappears after a predetermined time.

The advertisement may be displayed covering a portion of a specific area. Herein, the specific area may correspond to the main view of a charged image.

The advertisement guide message and the advertisement may be displayed as a PIP screen 1310. The PIP screen 1310 may be displayed overlapping on a charged image in order to cover a portion of the main view of the charged image.

When an advertisement is displayed during a predetermined time, a corresponding advertisement may be terminated and disappear from a screen and then, a charged image may be played. That is, in order to remove the advertisement from a screen, a user is required to maintain a specific area where an advertisement is shown for a predetermined time (for example, about 5 sec).

In some implementations, when an advertisement is displayed for a predetermined time, the mobile terminal 100 may display a skip button for terminating a corresponding advertisement on a screen. In some implementations, when the skip button is selected, a corresponding advertisement may be terminated and disappear from the screen and then, a charged image may be played.

Referring to FIG. 13, the PIP screen 1310 including an advertisement guide message is displayed overlapping on a specific area of a charged image. An advertisement starts to be displayed on the PIP screen 1310. After an advertisement is displayed for a predetermined time, it is terminated and disappears from a screen. In some implementations, a charged image may be played on the screen.

In such a way, in order to watch a charged image, a user may watch a specific area where an advertisement is shown or maintain a specific area where an advertisement is shown on a screen for a predetermined time. Thereby, the advertisement may be exposed to the user's eyes.

Replay Recommendation of 360-Degree Image Depending on Set Profile

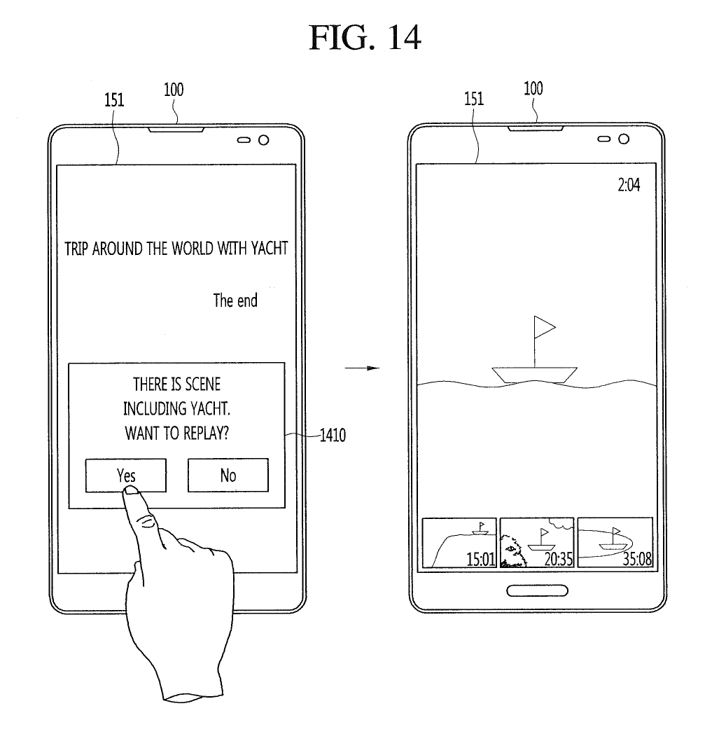

FIG. 14 illustrates an example mobile terminal that recommends the replay of a 360-degree image depending on a set profile.

The mobile terminal 100 may recommend the replay of a specific area of a 360-degree image on the basis of characteristics set by a user in advance. In some implementations, only a screen where preset characteristics are shown may be separated additionally and provided as a replay.

For this, a user may preset a profile for characteristics of a preferred person or thing. For example, a starring actor, a specific actor, the gender or age of a preferred person, or the color or shape of a preferred thing may be set.

A 360-degree image may be played at a viewing angle selected by a user. Accordingly, a specific area of a 360-degree image corresponding to a profile set by a user is played at a viewing angle different from the currently played viewing angle, so that the 360-degree image may be terminated without being displayed on a screen.

At a time point that the play of a 360-degree image is terminated, the mobile terminal 100 may recommend the replay of a specific area of a 360-degree image corresponding to a profile set by a user.

As shown in FIG. 14, when a 360-degree image is terminated, a message (1410) for recommending the replay of a screen corresponding to a preset profile is displayed on a screen.

When a user selects the replay, a 360-degree image for a playback time that preset characteristics are shown in the entire playback time of a 360-degree image is played. In some implementations, a plurality of playback time sections provided for replay and a still cut of a corresponding playback time section are displayed at a screen lower end.

While watching a 360-degree image, due to the characteristics of the 360-degree image, a user may miss and pass a screen where predetermined characteristics are shown. In some implementations, only a screen where preset characteristics are shown may be separated additionally and provided as a replay to a user.

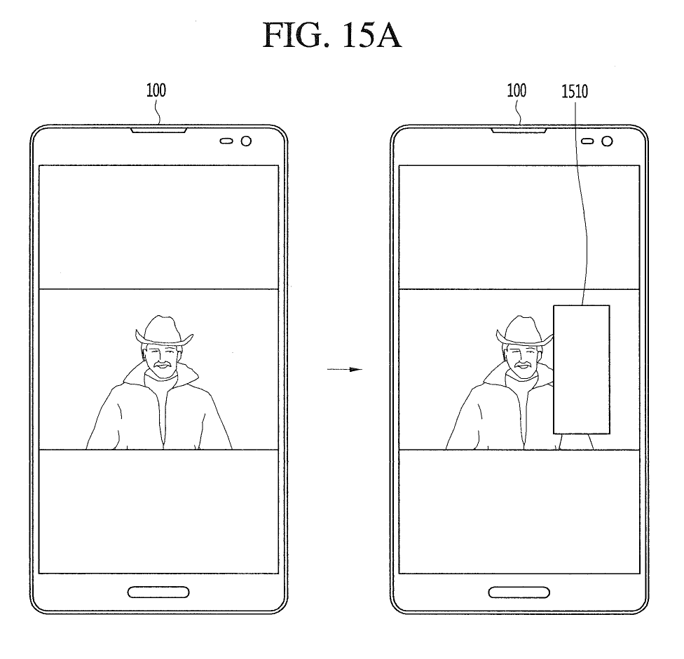

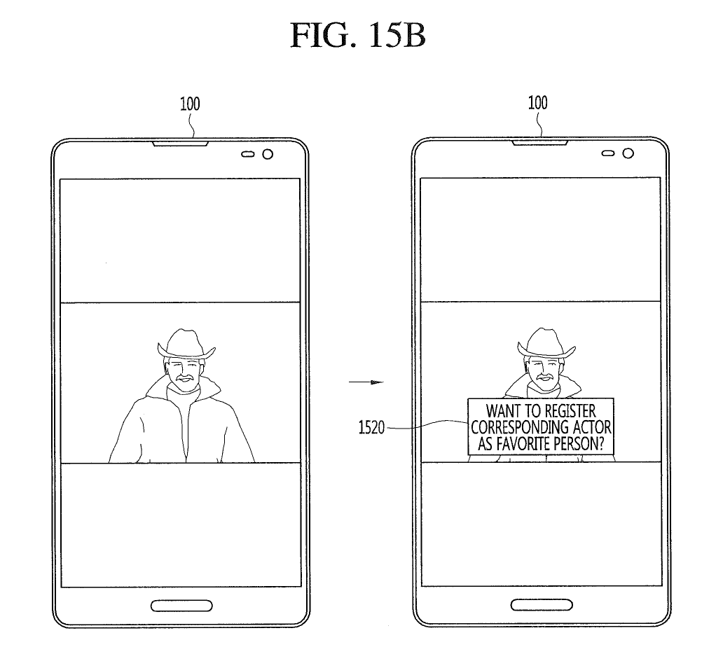

FIGS. 15A and 15B illustrate an example mobile terminal that sets a profile for recommending the replay of a 360-degree image.

The mobile terminal 100 may automatically set a profile for recommending the replay of a 360-degree image. In more detail, when a specific screen is maintained for a predetermined time, the mobile terminal 100 may search for and display videos relating to such a specific screen and provide a selection option for adding to a profile to a user.

When a user watches a specific screen or a specific area for a long time, the mobile terminal 100 maintains the specific screen or the specific area for a predetermined time.

The specific screen may include a person or a thing. In some implementations, the mobile terminal 100 may provide a video list relating to a person or a thing. In more detail, a video list where a person or a thing appears may be provided.

The mobile terminal 100 may provide, to a user, an option for selecting whether to add the characteristics of a person or thing that appears on a specific screen to a profile. Such an option may be displayed in a message form.

After the person or thing is registered as a preferred person or thing, the mobile terminal 100 may provide a 360-degree image corresponding to a profile as replay by performing image filtering and related search. In some implementations, when a 360-degree image is played as replay, it may be played at a viewing angle that a person or thing corresponding to an image profile appears.

As shown in FIG. 15A, a specific screen may be maintained on the mobile terminal 100 for a predetermined time. In some implementations, a video list 1510 relating to a person appearing on a specific screen is displayed. The video list 1510 may include a plurality of videos where a person appearing on a specific screen is cast.

As shown in FIG. 15B, a specific screen may be maintained on the mobile terminal 100 for a predetermined time. In some implementations, a message 1520 for asking whether to set a person appearing on the specific screen in a profile is displayed. The message 1520 may include a selection button for setting or unsetting a corresponding person in a profile.

Display of Multi View for 360-Degree Image

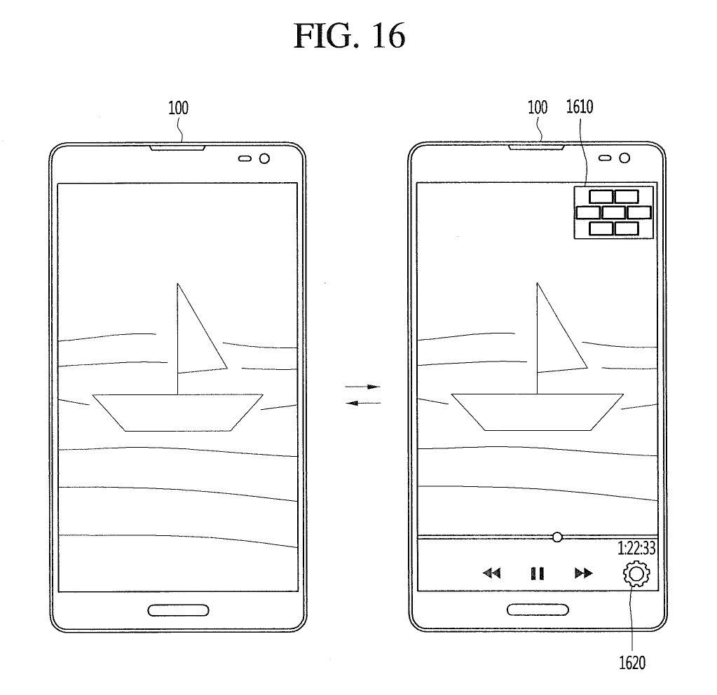

FIG. 16 illustrates an example mobile terminal that plays a 360-degree image.

When the mobile terminal 100 plays a 360-degree image, a screen for this may be displayed. In some implementations, a 360-degree image may be displayed in a default screen mode and a control screen mode.

The default screen mode may be defined as a state in which the display of a 360-degree image is executed. In some implementations, only a 360-degree image may be displayed on a screen. When a 360-degree image is played, the mobile terminal 100 starts to display it in a default screen mode. As long as an input signal for displaying a function icon or an input signal for changing to another screen mode is not detected, a 360-degree image may be maintained in a default screen mode continuously.

The control screen mode may be defined as a state in which the display and control of a 360-degree image are executed at the same time. When a 360-degree image is displayed in a control screen mode, a function icon for controlling the 360-degree image may be displayed on a screen in addition to the 360-degree image. When an input signal for displaying a function icon is detected, the function icon may be displayed.

The function icon may include a multi view icon, a setting icon, a progress bar, a rewind button, a fast forward button, and a stop button. Herein, the multi view icon may perform a function for displaying the multi view of a 360-degree image and the setting icon may perform a function for setting a 360-degree image related item. Such a function icon may be displayed on a screen to be controlled by a user.

The default screen mode and the control screen mode may be switched to each other based on an input signal for changing to another screen mode. In some implementations, when an input signal is not detected for a predetermined time in the control screen mode, it may be switched to the default screen mode.

In some implementations, an input signal for displaying a function icon and an input signal for changing to another screen mode may occur by various type touches such as short (or tap) touch, long touch, multi touch, drag touch, flick touch, pinch-in touch, pinch-out touch, swipe touch, and hovering touch on a touch screen.

As shown in the left drawing of FIG. 16, when playing a 360-degree image, the mobile terminal 100 displays the 360-degree image in a default screen mode. In some implementations, only a 360-degree image is displayed on a screen. In this state, when an input signal for displaying a function icon or an input signal for changing to another screen mode is detected, the mobile terminal 100 starts to display a 360-degree image in a control screen mode.

When a 360-degree image is displayed in the control screen mode, as shown in the right drawing of FIG. 16, function icons are displayed on the screen of the mobile terminal 100. The multi view icon 1610 is displayed at a screen right upper end and the setting icon 1620 is displayed at a screen right lower end.

In this state, when an input signal for changing to another screen mode is detected, the mobile terminal 100 may switch a 360-degree image to the default screen mode. In some implementations, when an input signal is not detected for a predetermined time in a state that a 360-degree image is displayed in the control screen mode, the 360-degree image may switch to the default screen mode.

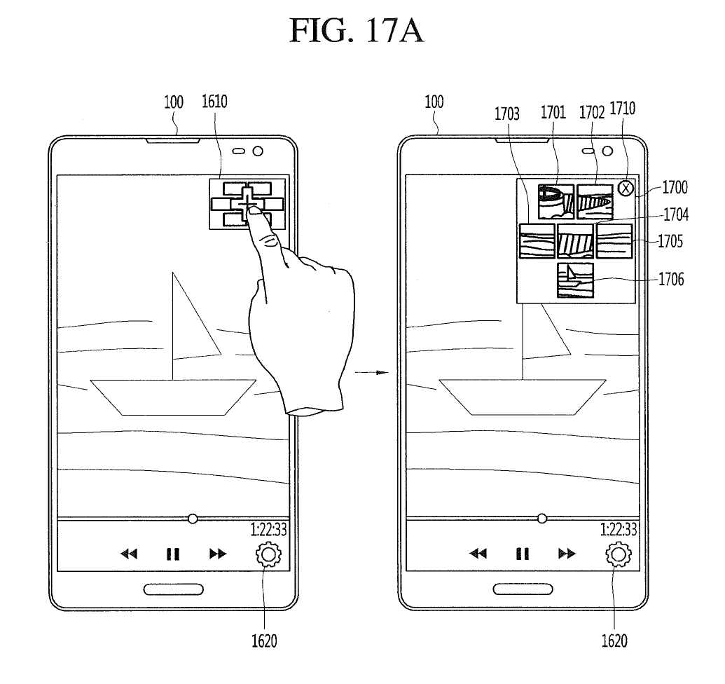

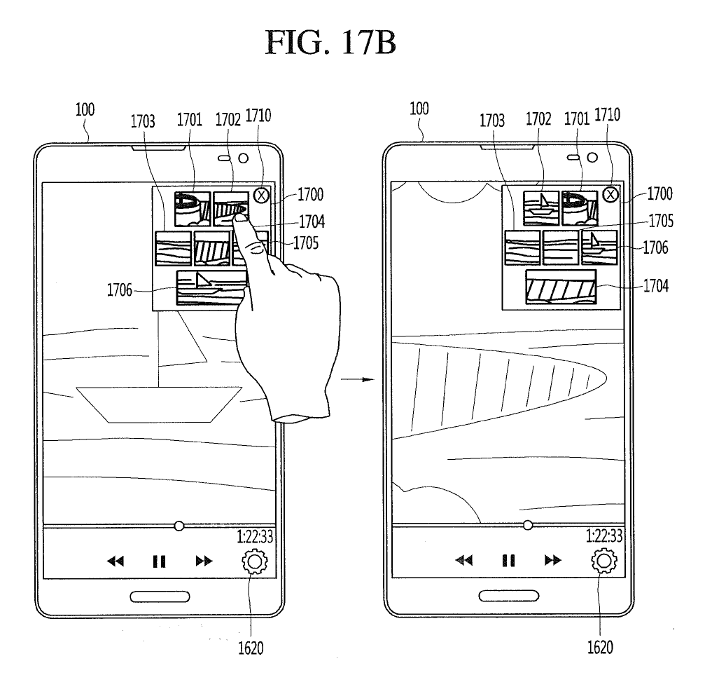

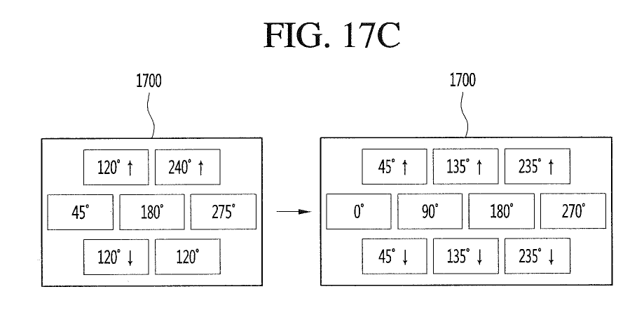

FIGS. 17A to 17C illustrates example mobile terminals that display a multi view for a 360-degree image.

The mobile terminal 100 may provide the multi view 1700 for the currently displayed 360-degree image. In more detail, when the multi view icon 1610 is selected, the mobile terminal 100 may display the multi view 1700 including a plurality of display areas on a screen and provide screens of different viewing angles corresponding to the number of display areas on the basis of the viewing angle of the current main screen.

The multi view 1700 may include a still cut of a scene played at a viewing angle different from the viewing angle of the currently displayed 360-degree image. In some implementations, the multi view 1700 may include a still cut of a scene played at a payback time different from the playback time of the currently displayed 360-degree image. The multi view 1700 may include a plurality of still cuts.

The multi view 1700 may include a plurality of display areas. A plurality of still cuts may be displayed to correspond to a plurality of display areas. In some implementations, each of the plurality of display areas may display a still cut for a scene played at a different viewing angle. At least one of the plurality of display areas may be displayed in a different size.

The multi view 1700 may be displayed in a PIP screen.

A close icon 1710 may be displayed at a right upper end of the multi view 1700. The close icon 1710 may perform a function for closing the multi view 1700. Therefore, when the close icon 1710 is selected, the multi view 1700 is closed and disappears from a screen.

When one of a plurality of display areas included in the multi view 1700 is selected, the mobile terminal 100 may display a 360-degree image corresponding to the selected display area on a main screen. The mobile terminal 100 may change the plurality of display areas in the multi view 1700 by reflecting a change of the viewing angle of the main screen in real time.

When one of the plurality of display areas is selected, a configuration of the multi view 1700 may be changed. In more detail, an arrangement of the plurality of display areas in the multi view 1700 or a content of a displayed image may be changed. In some implementations, the selected display area may be maintained in the multi view 1700 as it is and another image may be replaced and displayed in a corresponding display area. In some implementations, the selected display area may disappear from the multi view 1700 and the remaining display areas except for the selected display area may be arranged appropriately.

As shown in FIG. 17A, when a 360-degree image is displayed in a control screen mode, a multi view icon 1610 is selected. In some implementations, the mobile terminal 100 displays the multi view 1700 at a screen right upper end.

The multi view 1700 includes a plurality of display areas. In more detail, the plurality of display areas include a first display area 1701, a second display area 1702, a third display area 1703, a fourth display area 1704, a fifth display area 1705, and a sixth display area 1706. In some implementations, a still cut for a video scene at a different viewing angle is displayed in each of the first display area 1701, the second display area 1702, the third display area 1703, the fourth display area 1704, the fifth display area 1705, and the sixth display area 1706.

When a close icon 1710 displayed at a right upper end of the multi view 1700 is selected, the multi view 1700 is closed.

As shown in FIG. 17B, the second display area 1702 among the plurality of display areas displayed on the multi view 1700 is selected. When the second display area 1702 is selected, the mobile terminal 100 displays a 360-degree image displayed on the second display area 1702 in a main screen.

When the second display area 1702 is selected, it replaces the currently displayed 360-degree image with a 360-degree image of a different viewing angle and displays it. In more detail, a still cut of a 360-degree video scene at a viewing angle, which is played on the main screen before the second display area 1702 is selected, may be displayed in the second display area 1702. In some implementations, the size of each of the plurality of display areas is changed and accordingly, an arrangement of the plurality of display areas is changed.

In some implementations, as the number of display areas included in the multi view 1700 is increased, the multi view 1700 may divide a 360-degree image by more viewing angles and display them. Referring to FIG. 17C, the multi view 1700 displayed at the left includes seven display areas. As shown in the multi view 1700 shown at the right, if the number of display areas is increased to ten, a 360-degree image may be divided by more viewing angles and displayed.

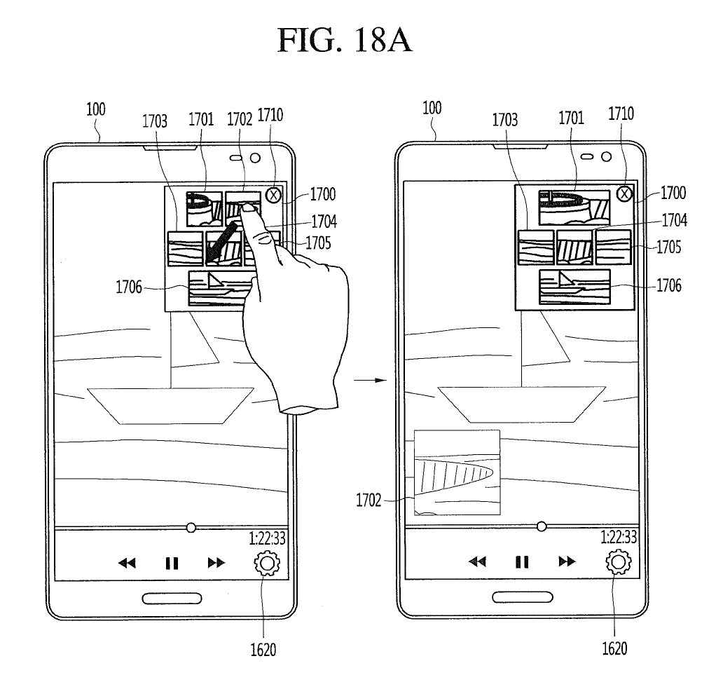

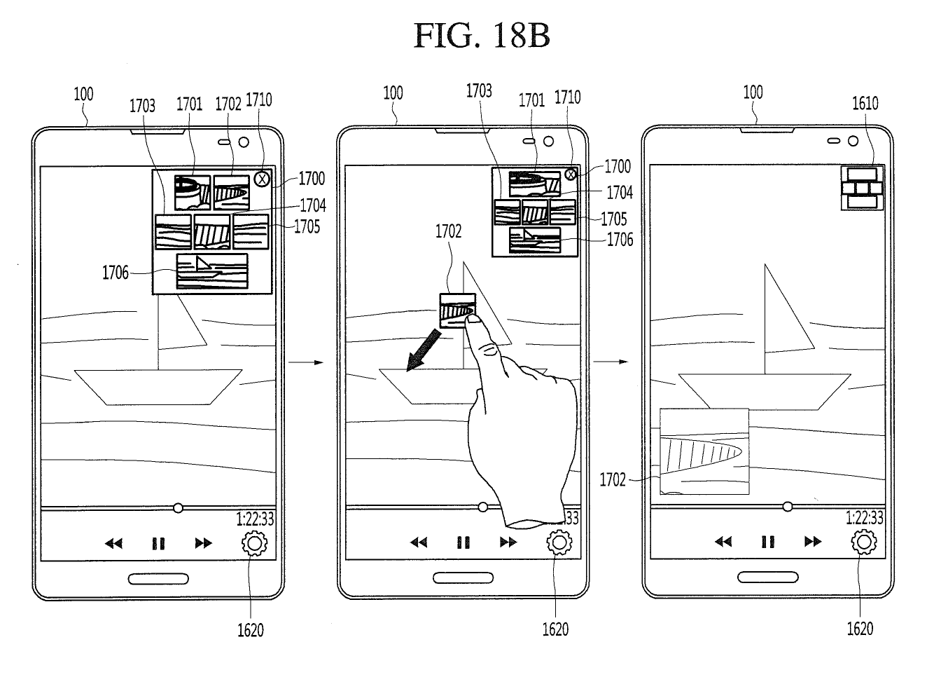

FIGS. 18A and 18B illustrate example mobile terminals that display a multi view for a 360-degree image.

When one of a plurality of display areas included in the multi view 1700 is moved out of the multi view 1700, the mobile terminal 100 may display the moved display area as a PIP screen. The moved display area may be displayed at the moved position. Thereby, a user may move the screen of a desired viewing angle from the multi view 1700 and display it as a PIP screen on the main screen.

When one of the plurality of display areas is moved, in correspondence thereto, the size of the multi view 1700 may be reduced. In more detail, while the selected display area is moved, the size of the multi view 1700 becomes smaller to be reduced to the size of a multi view icon.

When one of the plurality of display areas is moved, in correspondence thereto, the configuration of the multi view 1700 may be changed. In more detail, the arrangement of the plurality of display areas in the multi view 1700 or the viewing angle of a displayed image may be changed.

For convenience of description, it is assumed that an operation for moving a display area is a drag operation in FIGS. 18A and 18B.

As shown in FIG. 18A, while the multi view 1700 is displayed, the second display area 1702 is selected and dragged. In some implementations, the selected second display area 1702 is moved to the dragged position. As the second display area 1702 moves, a configuration of the multi view 1700 is changed. When the movement of the second display area 1702 is completed, a PIP screen including the second display area 1702 is generated at a corresponding position.

As shown in FIG. 18B, as the selected second display 1702 is dragged, in correspondence thereto, the size of the multi view 1700 becomes smaller to be switched to the multi view icon 1610.

When a finger is released from the selected second display area 1702, the second display area 1702 is displayed as a PIP screen at a position disposed at a corresponding time point. In some implementations, a close indicator for closing a PIP screen may be displayed on the PIP screen.

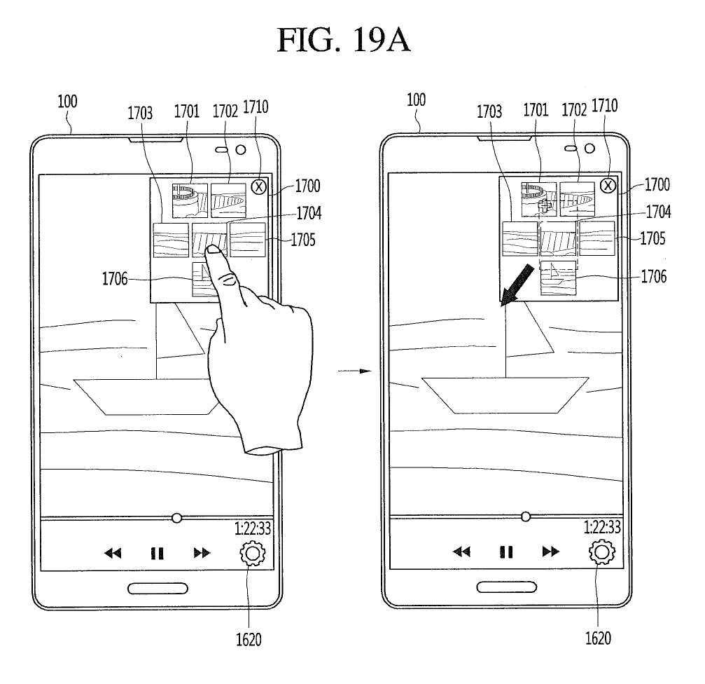

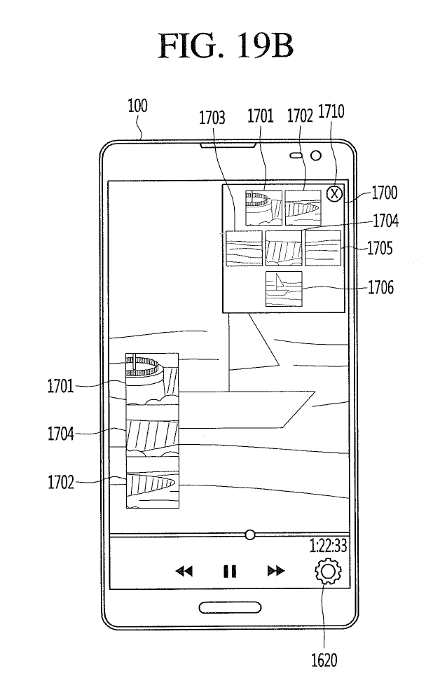

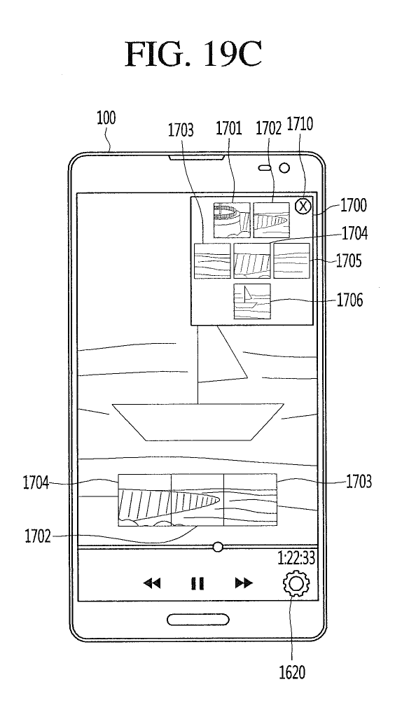

FIGS. 19A to 19C illustrate example mobile terminals that display a multi view for a 360-degree image.

When at least two of a plurality of display areas included in the multi view 1700 are selected, the mobile terminal 100 may display a PIP screen, which connects and displays the selected display areas, on a main screen. In some implementations, the selected display areas may be connected in a horizontal direction or a vertical direction in correspondence to a user's selection and may be displayed on a PIP screen.

When an input signal for pressing a display area long is detected, it may enter a multi selection mode for additionally selecting viewing angles in a horizontal or vertical direction. In a state of entering the multi selection mode, other display areas disposed in a horizontal direction or a vertical direction may be selected additionally. Thereby, at least two display areas to be displayed on a PIP screen may be selected.

In more detail, when one display area is pressed long, a dotted line area including a corresponding display area may be displayed. In some implementations, other display areas disposed in a horizontal direction or a vertical direction may be pressed long to be selected additionally.

Herein, instead of pressing a display area long, various type touches such as short (or tap) touch, long touch, multi touch, drag touch, flick touch, pinch-in touch, pinch-out touch, swipe touch, and hovering touch on a display area may be inputted.

When at least two selected display areas are dragged according to a continuous direction and disposed on a main screen, a PIP screen in a horizontal or vertical direction may be generated. All 360-degree images of a selected viewing angle are displayed and played on the generated PIP screen.

In some implementations, when the viewing angles of the selected display areas are spaced from each other, the mobile terminal 100 may add an unselected display area to connect the viewing angles and display it on the PIP screen. For example, when a display area for a viewing angle between 30° and 60° and a display area for a viewing angle between 90° and 120° are selected, the mobile terminal 100 may add a display area for a viewing angle between 600 and 90° to connect the display areas according to the viewing angle and display them. Thereby, an image for a viewing angle between 30° and 1200 is connected and played on the PIP screen.

Referring to FIG. 19A, the fourth display area 1704 is pressed long on the multi view 1700. In some implementations, a dotted line area including the fourth display area 1704 is generated. In above state, other display areas disposed in a horizontal direction or a vertical direction may be pressed long to be selected additionally.

A user may drag the selected display areas according to a continuous direction and position it on a main screen. Thereby, a PIP screen is generated on the main screen and at least two display areas arranged in a horizontal or vertical direction are played on the PIP screen.

Referring to FIG. 19B, the display areas are connected in a vertical direction and played. The first display area 1701, the fourth display area 1704, and the second display area 1702 are sequentially connected from the top and played on the PIP screen.

Referring to FIG. 19C, the display areas are connected in a horizontal direction and played. The fourth display area 1704, the second display area 1702, and the third display area 1703 are sequentially connected from the left and played on the PIP screen.

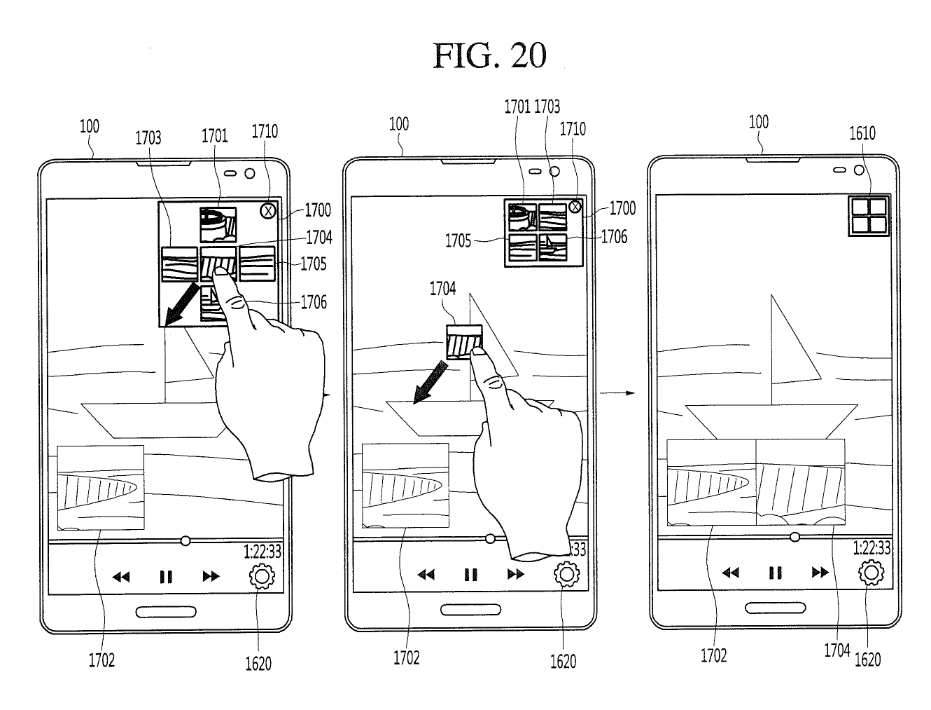

FIG. 20 illustrates an example mobile terminal that provides a multi view for a 360-degree image.

A display area may be added to the already generated PIP screen. In some implementations, the mobile terminal 100 may connect the added display area and play the PIP screen. The added display area may be connected in a horizontal direction or a vertical direction in correspondence to a user's selection.

Referring to FIG. 20, a PIP screen including the second display area 1702 is displayed on the main screen. In some implementations, the fourth display area 1704 is selected from the multi view 1700 and moved to the PIP screen.

When the fourth display area 1704 is moved and disposed to be connected to the PIP screen, the mobile terminal 100 connects the second display area 1702 and the fourth display area 1704 in a horizontal direction and displays them as a PIP screen. In some implementations, the second display area 1702 and the fourth display area 1704 are connected in horizontal direction and played.

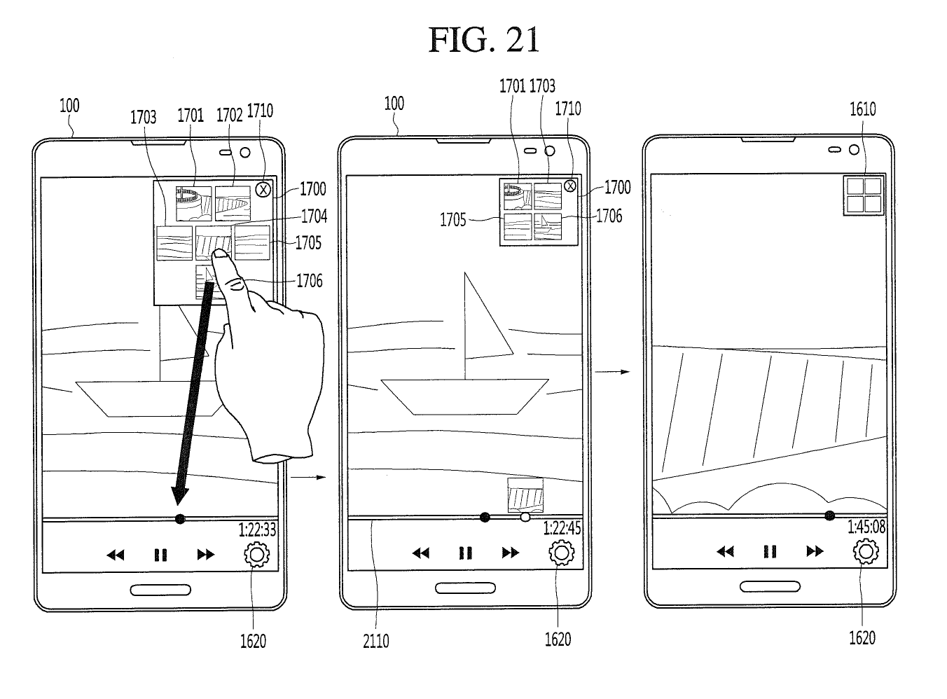

FIG. 21 illustrates an example mobile terminal that provides a multi view for a 360-degree image.

An image of a specific viewing angle included in the multi view 1700 may be reserved. In more detail, when a user drags a display area for displaying an image of a specific viewing angle among a plurality of display areas included in the multi view 1700 and disposes it at a predetermined time of a progress bar, an image of a specific viewing angle selected at a predetermined time may be reserved. In some implementations, when a predetermined time comes, a 360-degree image is played as automatically switching to a specific viewing angle.

Referring to FIG. 21, the fourth display area 1704 is moved on the multi view 1700 and disposed in correspondence to a predetermined time on a progress bar. In some implementations, the fourth display area 1704 is reserved at a predetermined time.

When the predetermined reserved time comes in a state that an image of a main screen is played, an image of a viewing angle displayed in the fourth display area 1704 starts to be played on the main screen.

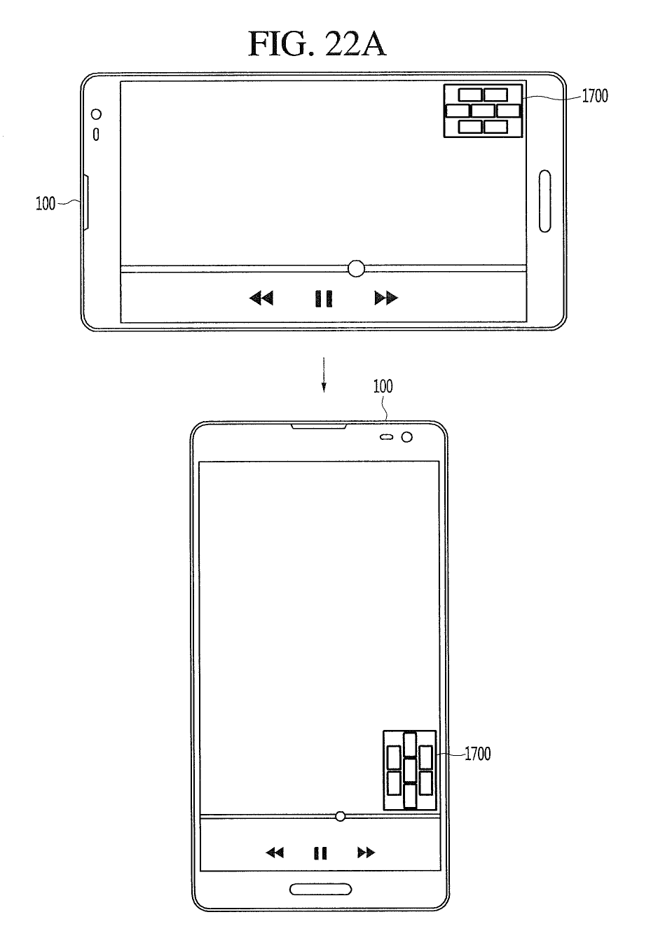

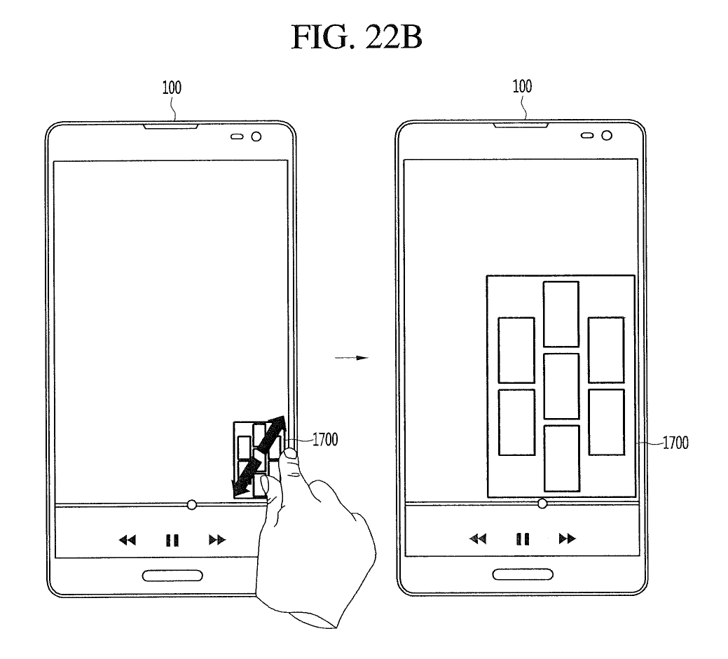

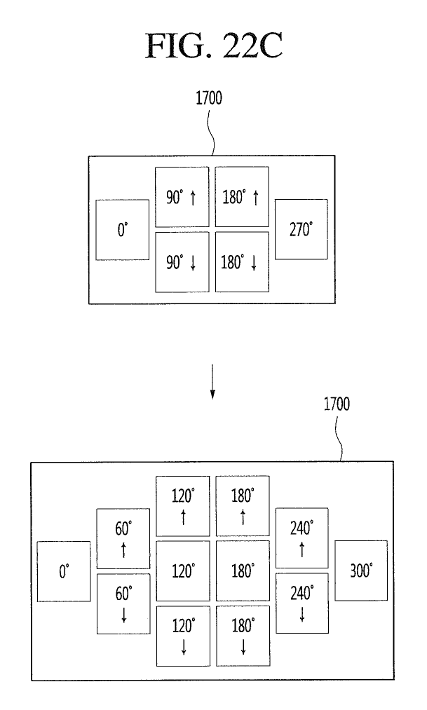

FIGS. 22A to 22C illustrate example mobile terminals that display a multi view for a 360-degree image.

When the mobile terminal 100 rotates, in correspondence thereto, the configuration of the multi view 1700 may be changed. In more detail, the mobile terminal 100 may display the multi view 1700 in a horizontal or vertical direction in correspondence to a screen direction.

The mobile terminal 100 may display in a landscape mode or a portrait mode. When displayed in the landscape mode, the multi view 1700 is displayed with a longer horizontal length than a vertical length and when displayed in the portrait mode, the multi view 1700 is displayed with a longer vertical length than a horizontal length.

When the screen of the mobile terminal 100 rotates in a vertical direction in the landscape mode, the multi view 1700 rotates in a vertical direction. Thereby, the sizes of a plurality of areas included in the multi view 1700 may be changed. The plurality of areas are displayed long in a vertical direction.

When the screen of the mobile terminal 100 rotates in a horizontal direction in the portrait mode, the multi view 1700 rotates in a horizontal direction. Thereby, the sizes of a plurality of areas included in the multi view 1700 may be changed. The plurality of areas are displayed long in a horizontal direction.

Referring to FIG. 22A, the screen of the mobile terminal 100 is displayed in the landscape mode, and in correspondence thereto, the multi view 1700 is displayed long in a horizontal direction. In this state, when the mobile terminal 100 rotates in a vertical direction, the screen of the mobile terminal 100 is switched to the portrait mode and accordingly, the multi view 1700 is displayed long in a vertical direction.

The multi view 1700 may be enlarged or reduced by a user's operation. In more detail, when a user pinches out the multi view 1700 by two fingers, the multi view 1700 is enlarged and displayed and when a user pinches in the multi view 1700 by two fingers, the multi view 1700 is reduced and displayed. Referring to FIG. 22B, as a user pinches out the multi view 1700 by two fingers, the multi view 1700 is enlarged.

When the multi view 1700 is enlarged, the size of a display area displayed in the multi view 1700 may be enlarged or the number of display areas may be increased.

When the size of a display area is enlarged, a 360-degree image displayed in the display area may be displayed in more detail.

When the number of display areas is increased, a 360-degree image of more various viewing angles may be displayed in the multi view 1700. Referring to FIG. 22C, the multi view 1700 displays images at different six viewing angles. In some implementations, as the multi view 1700 is enlarged, images of twelve viewing angles are displayed in the multi view 1700.

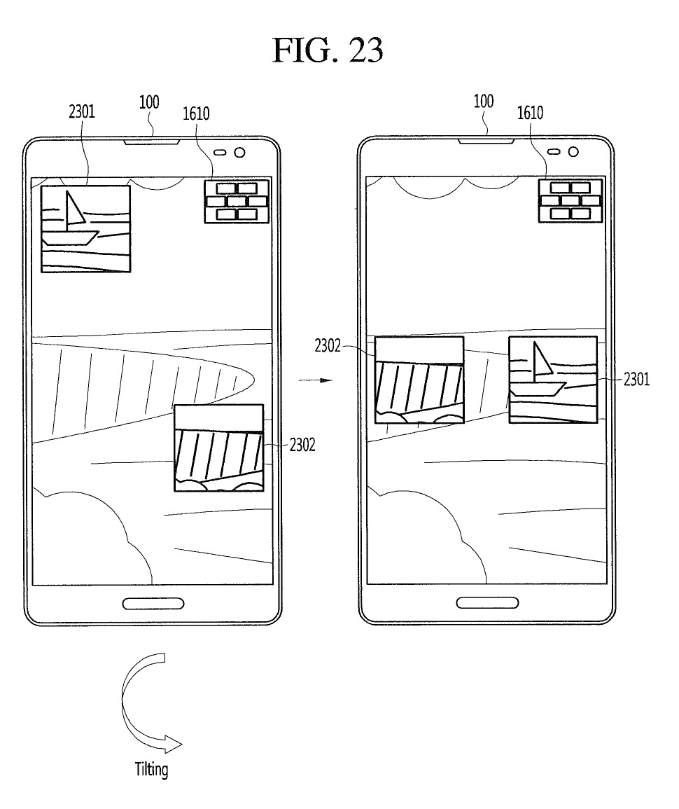

FIG. 23 illustrates an example mobile terminal that provides a multi view for a 360-degree image.

A plurality of PIP screens may be displayed on the main screen of the mobile terminal 100.

The plurality of PIP screens may be disposed freely regardless of a viewing angle by a user. When a user takes a predetermined operation to the mobile terminal 100 in this state (for example, shakes the mobile terminal 100), the mobile terminal 100 may re-arrange the plurality of PIP screens to correspond to a viewing angle. In more detail, the mobile terminal 100 may arrange the PIP screen of a viewing angle in a − direction at the left and arrange the PIP screen of a viewing angle in a + direction at the right, based on the viewing angle of the current main screen.

Referring to FIG. 23, a first PIP screen 2301 and a second PIP screen 2302 are displayed on the main screen. When a user shakes the mobile terminal 100 in this state, the mobile terminal 100 may re-arrange the first PIP screen 2301 and the second PIP screen 2302. Thereby, the second PIP screen 2302 is displayed at the screen left and the first PIP screen 2301 is displayed at the screen right.

Method of Displaying Advertisement in 360-Degree Image

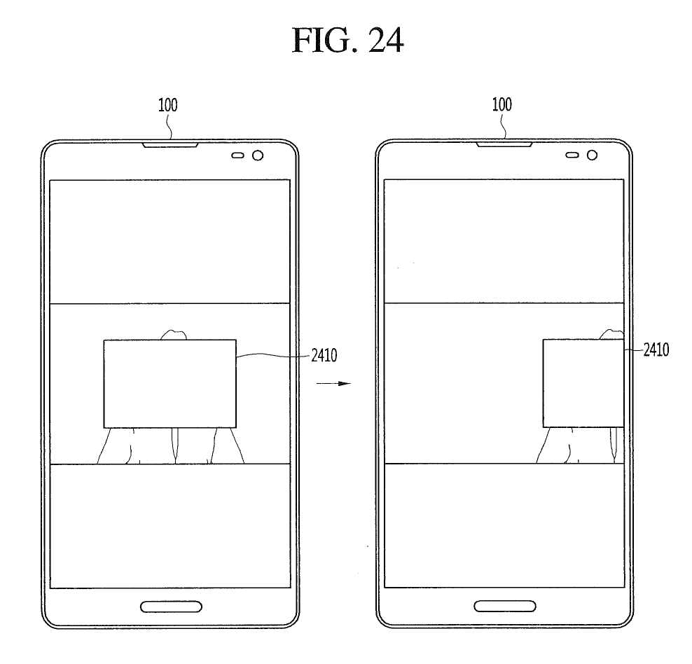

FIG. 24 illustrates an example mobile terminal that displays an advertisement on a 360-degree image.

The mobile terminal 100 may display an advertisement in a specific area of a 360-degree image and when the specific area of the 360-degree image is moved on a screen, in correspondence thereto, change the position of the advertisement. In some implementations, even when the screen is moved in a left/right or top/bottom direction, the specific area of the 360-degree image may be blocked continuously by the advertisement. Thereby, the mobile terminal 100 may allow a user to maintain a specific area for a predetermined time in order to induce the user to watch an advertisement.

Herein, the specific area may be an image of a specific viewing angle at which a specific person or thing is displayed. In some implementations, since an advertisement is displayed to cover a specific area, a user cannot see an image displayed at the specific area even when adjusting a viewing angle.

In some implementations, when an advertisement is played, a 360-degree image displayed on the main screen may be paused. After the advertisement's end, the advertisement that covers the specific area disappears from the screen. In some implementations, the 360-degree image of the main screen starts again from a paused part.

As shown in FIG. 24, an advertisement 2410 is disposed at a position of covering the face of a specific person. When a viewer moves a 360-degree image to the right in order to check the face of the specific person, the advertisement 2410 is moved to the right in correspondence thereto. Thereby, the advertisement 2410 covers the face of the specific person continuously and the viewer cannot check the face of the specific person. During this state, when the advertisement 2410 is played, the played advertisement 2410 may be exposed to the viewer's eyes.

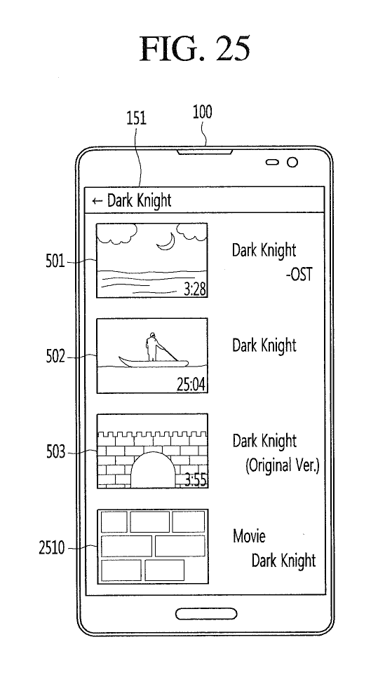

FIG. 25 illustrates an example mobile terminal that displays an advertisement on a 360-degree image.

When providing a search result list for a 360-degree image, the mobile terminal 100 may provide a preview screen for a charged image. Herein, the preview screen may be provided as a PIP screen.

The preview screen may be displayed in the search result list. In some implementations, a free image in the search result list is displayed as a representative thumbnail and a charged image may be displayed as a preview screen.

An image of a scene or a viewing angle, which attracts a viewer's interest, may be displayed on the preview screen. Thereby, this may induce a user's selection on a charged image.

As shown in FIG. 25, four search results are displayed in the search result list. In some implementations, a preview screen 2510 is displayed at the list end. An image of a specific scene or viewing angle is displayed on the preview screen 2510. By displaying the preview screen 2510, an effect for advertising a corresponding charged image may occur.

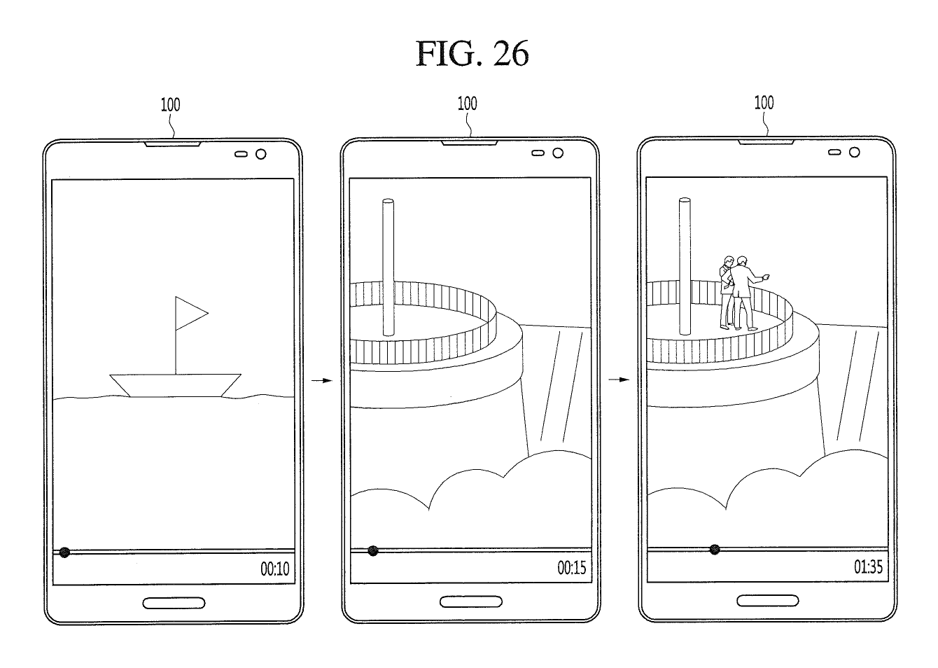

FIG. 26 illustrates an example mobile terminal that displays an advertisement on a 360-degree image.

When a 360-degree charged image is played, the mobile terminal 100 may fix the viewing angle of a corresponding charged image after a predetermined time.

The 360-degree charged image may be provided free of charge for a predetermined initial time. The viewing angle of a 360-degree charged image may be changed during a predetermined time and according thereto, a user may watch a corresponding 360-degree charged image at all viewing angles.

After a predetermined time elapses, the 360-degree charged image may be fixed at a specific viewing angle. In some implementations, a user cannot watch a corresponding 360-degree charged image at a viewing angle different from the specific viewing angle. Therefore, even if an image of an interesting scene is played at another viewing angle, this cannot be checked.

By making a payment on a corresponding 360-degree charged image, a user may watch a 360-degree charged image at a desired viewing angle.

As shown in FIG. 26, a 360-degree charged image is displayed for 15 sec without the limitation of a viewing angle. Until 15 sec elapse, a 360-degree charged image may be displayed at all viewing angles in correspondence to a user's manipulation.

After 15 sec elapse, the 360-degree charged image is fixed at a specific viewing angle. Accordingly, an image of a specific viewing angle starts to be displayed on a main screen. A viewer who wants to watch a 360-degree charged image at desired viewing angle is required to make a payment on a corresponding 360-degree charged image.

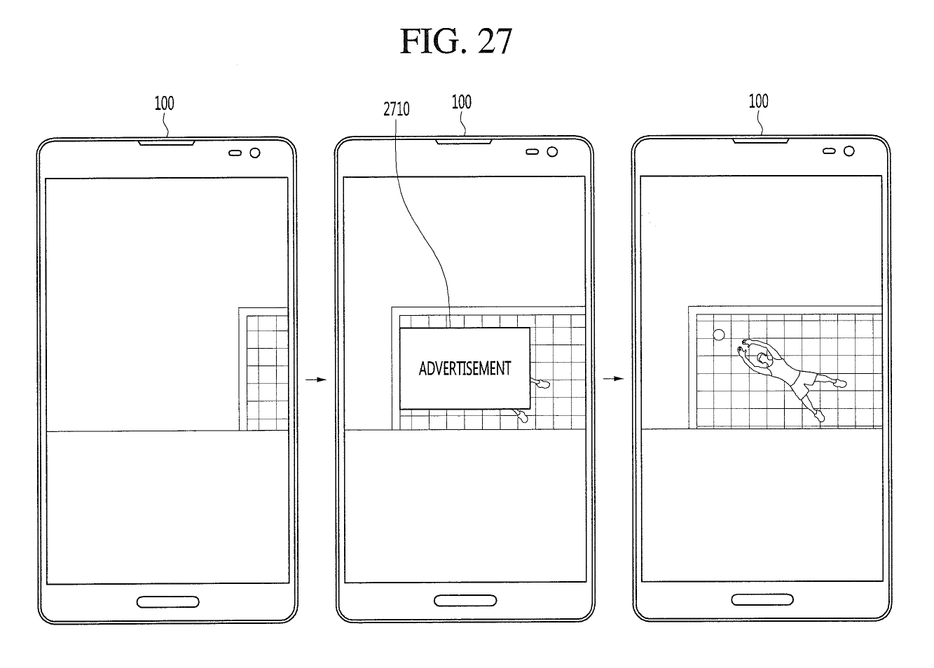

FIG. 27 illustrates an example mobile terminal that displays an advertisement on a 360-degree image.

When a 360-degree free image is played, the mobile terminal 100 may partially display an advertisement in a specific area. The specific area may be an area where an important scene or a scene that a viewer is interested in a corresponding 360-degree free image is displayed.

When a 360-degree free image is played at a viewing angle of displaying the specific area, the mobile terminal 100 may display an advertisement in the specific area. In some implementations, the mobile terminal 100 may provide a payment window together with an advertisement.

If wanting to watch a specific area, a viewer is required to make a payment. When a payment is made, a viewer may freely watch a 360-degree free image without the limitation of a viewing angle.

As shown in FIG. 27, a viewing angle is moved to allow a specific area of a 360-degree free image to be disposed at the center. In some implementations, an advertisement 2710 is displayed in the specific area. A user cannot watch the specific area due to the advertisement 2710. If a viewer who wants to watch the specific area makes a payment, the advertisement 2710 displayed in the specific area disappears.

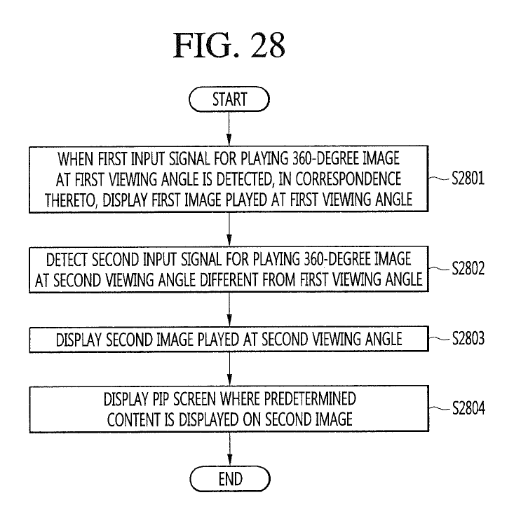

FIG. 28 illustrates an example operating process of a mobile terminal.

When detecting a first input signal for playing a 360-degree image at a first viewing angle, in correspondence thereto, the mobile terminal 100 displays a first image at the first viewing angle in operation S2801.

The mobile terminal 100 detects a second input signal for playing the 360-degree image at a second viewing angle different from the first viewing angle in operation S2802.

The mobile terminal 100 displays a second image played at the second viewing angle in operation S2803.

The mobile terminal 100 displays a PIP screen where a predetermined content is shown, on the second image in operation S2804.

In some implementations, only a 360-degree image may be checked from a search result list.

In some implementations, when a 360-degree image is played, an advertisement content may be effectively provided to a viewer to correspond to the characteristics of the 360-degree image.

In some implementations, when a 360-degree image is played, an image provided at a viewing angle other than the currently played viewing angle may be provided to a viewer through various methods.

The subject matter described in this application can also be implemented as computer readable codes on a computer readable recording medium. The computer readable recording medium is any data storage device that can store data which can be thereafter read by a computer system. Examples of the computer readable recording medium include magnetic storage media (e.g., ROM, floppy disks, hard disks, etc.) and optical recording media (e.g., CD-ROMs, or DVDs) and carrier waves (e.g., transmission through the Internet). In some implementations, the computer may include the control unit 180 of a terminal. Accordingly, the detailed description is not construed as being limited in all aspects and should be considered as illustrative.

What is claimed is:

1. A mobile terminal comprising:
a display unit that is configured to display a 360-degree image;
a sensing unit that is configured to detect an input signal; and
a control unit that is configured to:
control the display unit;
control the sensing unit;
display, on the display unit, a first image at a first viewing angle in response to the sensing unit detecting a first input signal for displaying the 360-degree image at the first viewing angle; and
display, on the display unit, a second image at a second viewing angle in response to the sensing unit detecting a second input signal for displaying the 360-degree image at the second viewing angle that is different than the first viewing angle, wherein the second image includes a picture-in-picture (PIP) screen that displays predetermined content.

2. The mobile terminal of claim 1, wherein the predetermined content comprises at least one of an advertisement or a payment window.

3. The mobile terminal of claim 2, wherein the control unit is configured to display the second image and the PIP screen by fixing the 360-degree image at the second viewing angle based on the 360-degree image being displayed for a predetermined amount of time.

4. The mobile terminal of claim 2, wherein the control unit is configured to increase a size of the PIP screen based on the sensor unit detecting a third input signal for changing the viewing angle of the 360-degree image to the second viewing angle and based on the viewing angle of the 360-degree image approaching the second viewing angle.

5. The mobile terminal of claim 2, wherein the control unit is configured to cover a specific object in the second image with the PIP screen.

6. The mobile terminal of claim 5, wherein the control unit is configured to overlap and display the PIP screen on the specific object based on the specific object being moved.

7. The mobile terminal of claim 1, wherein the predetermined content comprises a plurality of display areas for displaying the 360-degree image at different viewing angles.

8. The mobile terminal of claim 7, wherein the control unit is configured to display a second PIP screen for displaying a display area of the plurality of display areas at a position based on the display area being moved outside of the PIP screen that includes the plurality of display areas and being moved to the position on the second image.

9. The mobile terminal of claim 8, wherein the control unit is configured to decrease a size of the PIP screen based on the display area being moved.

10. The mobile terminal of claim 7, wherein the control unit is configured to:
display, on the display unit a progress bar that represents a display time of the 360-degree image on the display unit; and
display, on the display unit, the 360-degree image at a viewing angle of a display area of the plurality of display areas based on the display area being moved outside of the PIP screen that includes the plurality of display areas and being positioned at one point on the progress bar and then the progress bar approaching the one point.

11. The mobile terminal of claim 7, wherein the control unit is configured to display, on the display unit, a second PIP screen that connects two display areas of the plurality of display areas based on the two display areas being sequentially moved out of the PIP screen that includes the plurality of display areas and on to the second image.

12. The mobile terminal of claim 11, wherein the control unit is configured to display, on the display unit, the second PIP screen for connecting and displaying an unselected display area and the two display areas to connect viewing angles to each other based on the viewing angles of the two display areas being spaced from each other.

13. The mobile terminal of claim 7, wherein the control unit is configured to display, on the display unit, a second PIP screen for displaying each of two display areas of the plurality of display areas at different positions based on the two display areas being moved out of the PIP screen that includes the plurality of display areas and onto the second image at the different positions.

14. The mobile terminal of claim 7, wherein the control unit is configured to change at least one of a number or sizes of the plurality of display areas based on the sensor unit detecting an input signal for changing a size of the predetermined content.

15. A method of operating a mobile terminal, the method comprising:
detecting a first input signal for displaying a 360-degree image at a first viewing angle;
in response to the first input signal, displaying a first image at the first viewing angle;
detecting a second input signal for displaying the 360-degree image at a second viewing angle that is different from the first viewing angle; and
in response to the second input signal, displaying a second image at the second viewing angle, wherein the second image includes a picture-in-picture (PIP) screen that displays predetermined content.

16. The method of claim 15, wherein the predetermined content comprises at least one of an advertisement or a payment window.

17. The method of claim 16, further comprising:
based on the 360-degree image being displayed for a predetermined time, displaying the second image and the PIP screen by fixing the 360-degree image at the second viewing angle.

18. The method of claim 16, further comprising:
covering a specific object in the second image by overlapping the PIP screen onto the specific object.

19. The method of claim 15, wherein the predetermined content comprises a plurality of display areas for displaying the 360-degree image at different viewing angles.

20. The method of claim 19, further comprising displaying a second PIP screen for displaying a display area of the plurality of display areas at a position based on the display area being moved out of the PIP screen to the position on the second image.
